(19) United States
(12) Patent Application Publication
(10) Pub. No.: US 2020/0258029 A1
(43) Pub. Date: Aug. 13, 2020

(54) APPARATUS AND METHOD FOR MANAGING SCHEDULE IN ELECTRONIC DEVICE

(71) Applicant: Samsung Electronics Co., Ltd., Suwon-si (KR)

(72) Inventors: Joohee JUNG, Suwon-si (KR); Para KANG, Suwon-si (KR); Joohee PARK, Suwon-si (KR); Hyejin LEE, Suwon-si (KR)

(21) Appl. No.: 16/790,521

(22) Filed: Feb. 13, 2020

(30) Foreign Application Priority Data
Feb. 13, 2019 (KR) 10-2019-0016490

(51) Int. Cl. G06Q 10/06; G06Q 10/10; G06N 3/08; G06N 3/04

(52) U.S. Cl. CPC G06Q 10/063116; G06N 3/0472; G06N 3/08; G06Q 10/109

(57) ABSTRACT

A method and apparatus for managing a schedule. According to various embodiments, an electronic device includes a display, and at least one processor configured to be connected to the display. The processor is configured to: acquire schedule information associated with operation of the device from a user, generate at least one first schedule based on the schedule information, identify at least one second schedule stored in a calendar application, identify a section in which time information of the first schedule and time information of the second schedule at least partially overlap each other by comparing the time information of the first schedule with the time information of the second schedule, and output an option capable of changing the operation of the device related to the first schedule based on the overlapping section between the first schedule and the second schedule. Various embodiments are possible.

### CROSS-REFERENCE TO RELATED APPLICATION

This application is based on and claims priority under 35 U.S.C. 119 to Korean Patent Application No. 10-2019-0016490 filed on Feb. 13, 2019 in the Korean Intellectual Property Office, the disclosure of which is herein incorporated by reference in its entirety.

### BACKGROUND

### 1. Field

Various embodiments relate to a method and apparatus for managing a schedule in an electronic device.

### 2. Description of Related Art

With the recent development of digital technology, various types of electronic devices such as mobile communication terminals, smart phones, tablet personal computers (PCs), notebooks, wearable devices, digital cameras, personal computers, Internet of things (IoT) devices, and the like are widely used.

The electronic device may provide a calendar application for managing a user's schedule, and the user may register and manage his or her schedule using the calendar application. For example, the user may execute the calendar application in the electronic device and may register a schedule (or input information related to the schedule) required by the user using the calendar application. When the user's schedule is registered through the calendar application, the electronic device may perform schedule management (e.g., scheduling) on the registered schedule, and may feed back (e.g., display information or output sound effect) schedule-related input information from the corresponding schedule to the user.

However, as to schedule management in a conventional electronic device, scheduling related to a user's schedule registered using a calendar application by the user of the electronic device is performed, and only simple feedback on the corresponding schedule is provided based on the scheduling result.

The above information is presented as background information only to assist with an understanding of the disclosure. No determination has been made, and no assertion is made, as to whether any of the above might be applicable as prior art with regard to the disclosure.

### SUMMARY

Various embodiments provide a method and apparatus for registering and managing a schedule for each user associated with a plurality of users and a schedule associated with a device based on a calendar application in an electronic device.

Various embodiments provide a method and apparatus for providing feedback related to a device based on a user schedule for each user and a device schedule (e.g., an operating schedule of a device) in an electronic device.

Various embodiments provide a method and apparatus for recommending, when a user schedule and a device schedule conflict in an electronic device, an operation time of a device (e.g., an operation completion time), a use function, and/or an option associated with a device operation in which the schedules do not conflict with each other.

Various embodiments provide an intelligent schedule management method and apparatus for providing a recommendation related to a device schedule or controlling a device according to a usage pattern (or context) for each user in conjunction with schedules of multiple users in an electronic device.

An electronic device according to various embodiments includes: a display; and at least one processor configured to be connected to the display, wherein the processor is configured to acquire schedule information associated with an operation of a device from a user, to generate at least one first schedule based on the schedule information, to identify at least one second schedule stored in a calendar application, to identify a section in which time information of the first schedule and time information of the second schedule at least partially overlap each other by comparing the time information of the first schedule with the time information of the second schedule, and to output an option capable of changing the operation of the device related to the first schedule based on the at least partially overlapping section between the first schedule and the second schedule.

An electronic device according to various embodiments includes: a communication circuit; an output device; and at least one processor configured to be connected to the communication circuit and the output device, wherein the processor is configured to acquire schedule information associated with an operation of the electronic device from a user, to generate a schedule based on the schedule information, to transmit the schedule information to an external server using the communication circuit, to acquire options capable of changing the operation of the electronic device related to the schedule, to output the options using the output device, to select any one option of the options based on a user input, and to change the schedule based on schedule information of the selected option.

A method of operating an electronic device according to various embodiments includes: acquiring schedule information associated with an operation of a device from a user; generating at least one first schedule based on the schedule information; identifying at least one second schedule stored in a calendar application; identifying a section in which time information of the first schedule and time information of the second schedule at least partially overlap each other by comparing the time information of the first schedule with the time information of the second schedule; and outputting an option capable of changing the operation of the device related to the first schedule based on the at least partially overlapping section between the first schedule and the second schedule.

In order to solve the above problems, various embodiments may include a computer-readable recording medium that stores a program for executing the method in the processor.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device in a network environment according to various embodiments;

FIG. 2 is a block diagram illustrating an integrated intelligence system according to various embodiments;

FIG. 3 is a diagram illustrating an example in which relationship information between a concept and an action is stored in a database according to various embodiments;

FIG. 4 is a diagram illustrating a screen in which a UE processes a voice input received through an intelligent app according to various embodiments;

FIG. 5 is a diagram illustrating a system for schedule management according to various embodiments;

FIG. 6 is a flowchart illustrating a method of operating an electronic device according to various embodiments;

FIG. 7 is a flowchart illustrating a method of operating an electronic device according to various embodiments;

FIG. 8A is a diagram illustrating an example of a schedule type according to various embodiments, FIG. 8B is a diagram illustrating an example of a schedule type according to various embodiments, and FIG. 8C is a diagram illustrating an example of a schedule type according to various embodiments;

FIG. 9 is a diagram illustrating an identification tag associated with a schedule type according to various embodiments;

FIG. 10 is a diagram illustrating an identification tag associated with a schedule type according to various embodiments;

FIG. 11 is a flowchart illustrating a method of operating an electronic device according to various embodiments;

FIG. 12 is a flowchart illustrating an operation method of providing a recommendation regarding a device schedule in an electronic device according to various embodiments;

FIG. 13 is a flowchart illustrating an operation method of providing a recommendation regarding a device schedule in an electronic device according to various embodiments;

FIG. 14 is a diagram illustrating an operation of separating a task in an electronic device according to various embodiments;

FIG. 15 is a diagram illustrating an operation of providing a recommendation regarding a device in an electronic device according to various embodiments;

FIG. 16 is a diagram illustrating an operation between an electronic device and an external server according to various embodiments;

FIG. 17A is a diagram illustrating an example in which a user interface is provided according to various embodiments;

FIG. 17B is a diagram illustrating an example of changing an operation of a device according to various embodiments;

FIG. 18 is a diagram illustrating an example in which a user interface is provided according to various embodiments;

FIG. 19 is a diagram illustrating an example in which a user interface is provided according to various embodiments;

FIG. 20A is a diagram illustrating another example of adding a device schedule according to various embodiments;

FIG. 20B is a diagram illustrating an example in which a user interface is provided according to various embodiments;

FIG. 21 is a diagram illustrating an example in which a user interface is provided according to various embodiments;

FIG. 22 is a diagram illustrating an example of an interface configuration related to a user interface according to various embodiments;

FIG. 23 is a diagram illustrating another example of a user interface according to various embodiments;

FIG. 24 is a diagram illustrating an example in which a user interface is provided according to various embodiments, and FIG. 25 is a diagram illustrating an example in which a user interface is provided according to various embodiments;

FIG. 26 is a diagram illustrating an example of recommending a configuration regarding a device schedule based on a user interface according to various embodiments;

FIG. 27 is a diagram illustrating an example of recommending a configuration regarding a device schedule based on a user interface according to various embodiments;

FIG. 28 is a diagram illustrating an example of recommending a configuration regarding a device schedule based on a user interface according to various embodiments, and FIG. 29 is a diagram illustrating an example of recommending a configuration regarding a device schedule based on a user interface according to various embodiments;

FIG. 30 is a diagram illustrating an example of recommending a configuration regarding a device schedule based on a user interface according to various embodiments, and FIG. 31 is a diagram illustrating an example of recommending a configuration regarding a device schedule based on a user interface according to various embodiments;

FIG. 32 is a diagram illustrating an example of recommending a configuration regarding a device schedule based on a user interface according to various embodiments;

FIG. 33 is a diagram illustrating an example of recommending a configuration regarding a device schedule based on a user interface according to various embodiments;

FIG. 34A is a diagram illustrating an example in which a user interface is provided according to various embodiments, FIG. 34B is a diagram illustrating an example in which a user interface is provided according to various embodiments, and FIG. 34C is a diagram illustrating an example in which a user interface is provided according to various embodiments;

FIG. 35 is a diagram illustrating an example in which a user interface is provided according to various embodiments; and

FIG. 36A is a diagram illustrating an example in which a user interface is provided according to various embodiments, and FIG. 36B is a diagram illustrating an example in which a user interface is provided according to various embodiments.

### DETAILED DESCRIPTION

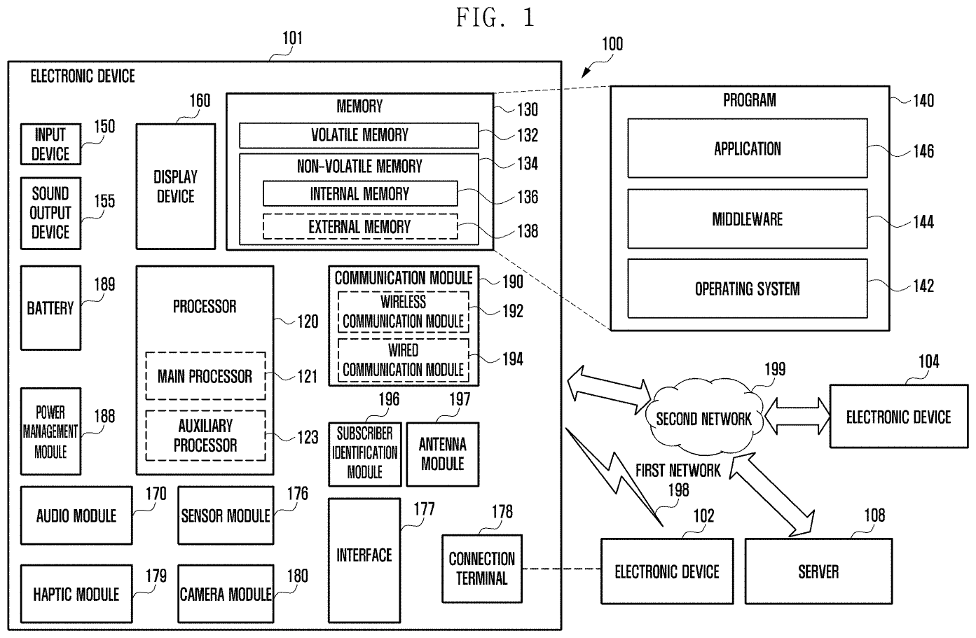

FIGS. 1 through 36A, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

According to an electronic device and a method of operating the same according to various embodiments, with respect to devices increasing in a smart home environment, it is possible to provide an intelligent system that can intelligently control a device according to a usage pattern for each user in conjunction with a schedule of multiple users. According to various embodiments, when a device schedule (e.g., a new schedule) according to a user input and a user schedule neighboring to the device schedule are in conflict, it is possible to propose a change option (e.g., an option associated with device usage and/or control) associated with the operation required time of the device. According to an embodiment, it is possible to propose an option of changing the operation required time of a device to match the operation completion time of the device to a user schedule. According to an embodiment, it is possible to propose an option of searching for a user who can respond to the automatic completion time of a corresponding device with reference to schedules of other users and extracting a top user according to a frequency ranking of using the corresponding device to request a task. According to an embodiment, it is possible to analyze schedule information of a user to generate an identification tag and to suggest the operation of an additional device associated with the identification tag. According to various embodiments, even when a device schedule and a user schedule are in conflict, it is possible to parallelize the device schedule while enabling the user schedule of the user, thereby improving user convenience.

FIG. 1 illustrates an electronic device 101 in a network environment 100 according to an embodiment.

Referring to FIG. 1, the electronic device 101 in the network environment 100 may communicate with an electronic device 102 via a first network 198 (e.g., a short-range wireless communication network), with an electronic device 104 or a server 108 via a second network 199 (e.g., a long-range wireless communication network), or with the electronic device 104 via the server 108, and may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) card 196, and an antenna module 197. At least one (e.g., the display device 160 or the camera module 180) of the components may be omitted from the electronic device 101, or one or more other components may be added in the electronic device 101. Some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. The processor 120 may load a command or data received from another component (e.g., the sensor module 176 or the communication module 190) in the volatile memory 132, process the command or the data stored in the volatile memory 132, and store resulting data in non-volatile memory 134. The processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101 and may include software (e.g., the program 140) and input data or output data for a command related thereto. The memory 130 may include the volatile memory 132 or the non-volatile memory 134.

The program 140 may be stored in the memory 130 as software, and may include an operating system (OS) 142, middleware 144, or an application 146.

The input device 150 may receive a command or data to be used by another component (e.g., the processor 120) of the electronic device 101, from the outside (e.g., a user) of the electronic device 101, and may include a microphone, a mouse, a keyboard, or a digital pen (e.g., a stylus pen).

The sound output device 155 may output sound signals to the outside of the electronic device 101 and may include a speaker or a receiver. The speaker may be used for general purposes, such as playing multimedia or playing record, and the receiver may be used for incoming calls and may be implemented as separate from, or as part of the speaker.

The display device 160 may visually provide information to the outside (e.g., a user) of the electronic device 101 and may include a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa, and may obtain the sound via the input device 150, or output the sound via the sound output device 155 or a headphone of an external electronic device (e.g., an electronic device 102) directly (e.g., over wires) or wirelessly coupled with the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state, and may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., over wires) or wirelessly, and may include a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102), and may include a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation, and may include a motor, a piezoelectric element, or an electric stimulator.

The camera module 180 may capture a still image or moving images and may include one or more lenses, image sensors, image signal processors, or flashes.

The power management module 188 may manage power supplied to the electronic device 101, and may be implemented as at least part of a power management integrated circuit (PMIC).

The battery 189 may supply power to at least one component of the electronic device 101, and may include a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101 and may include an antenna including a radiating element composed of a conductive material or a conductive pattern formed in or on a substrate (e.g., a PCB). The antenna module 197 may include a plurality of antennas. In such a case, at least one antenna appropriate for a communication scheme used in the communication network, such as the first network 198 or the second network 199, may be selected by the communication module 190 (e.g., the wireless communication module 192) from the plurality of antennas. The signal or the power may then be transmitted or received between the communication module 190 and the external electronic device via the selected at least one antenna. Another component (e.g., an RFIC) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 and 104 may be a device of a same type as, or a different type, from the electronic device 101.

All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing, as at least part of a reply to the request. To that end, a cloud, distributed, or client-server computing technology may be used, for example.

The electronic device 101 according to embodiments may be one of various types of electronic devices, such as a portable communication device (e.g., a smartphone), a computer device, a portable multimedia device, a portable medical device, a camera, a wearable device, or a home appliance. However, the electronic devices are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., over wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Prior to describing various embodiments, an integrated intelligence system to which an embodiment can be applied will be described.

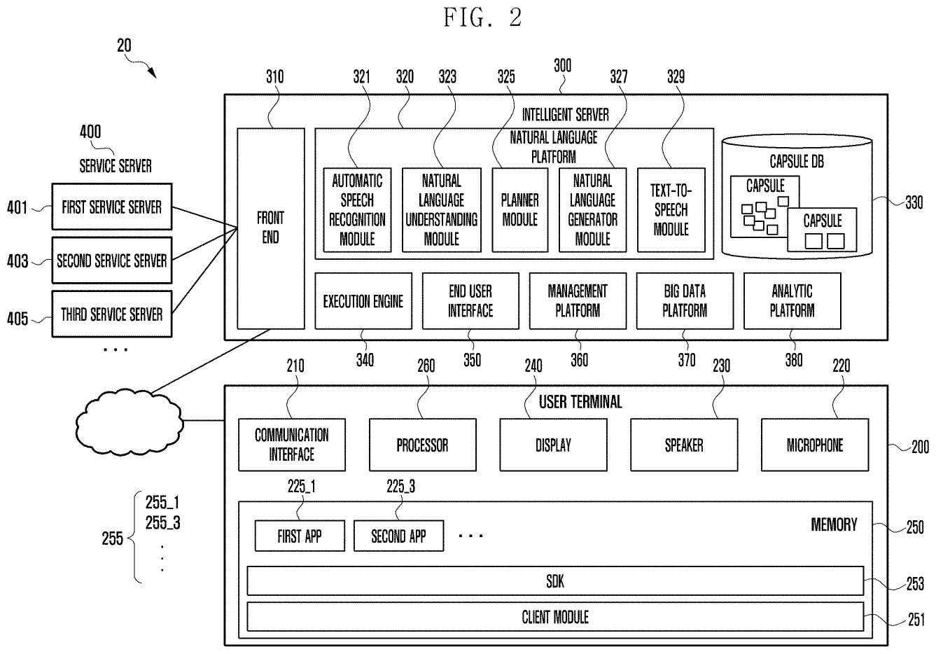

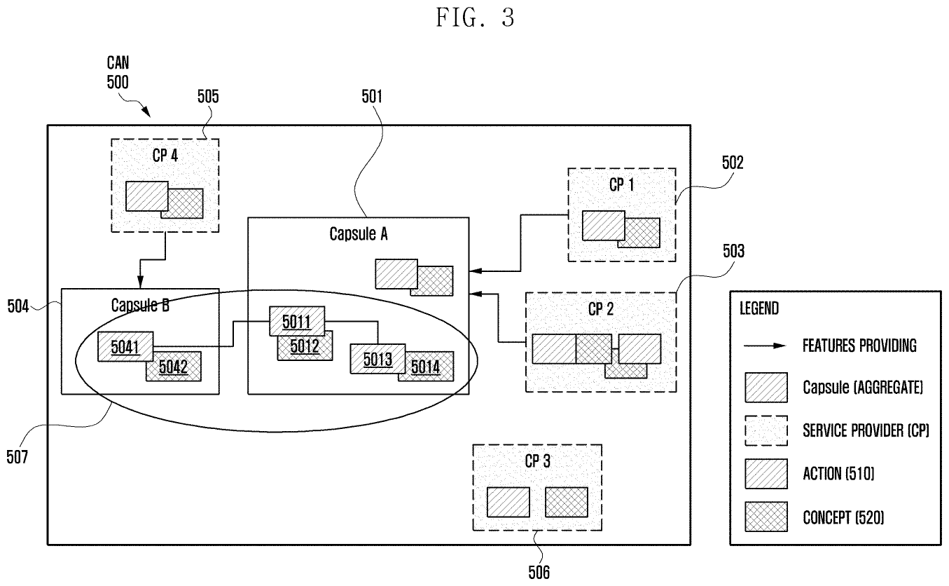

FIG. 2 is a block diagram illustrating an integrated intelligence system 20 according to various embodiments.

Referring to FIG. 2, the integrated intelligence (or artificial intelligent (AI)) system 20 according to an embodiment may include a UE 200 (e.g., the electronic device 101 in FIG. 1), an intelligent server 300, and a service server 400.

The UE 200 according to an embodiment may be a terminal device (or the electronic device 101) that can be connected to the Internet, and may be, for example, a mobile phone, a smart phone, a personal digital assistant (PDA), a notebook computer, a television (TV), a major appliance or domestic appliance, a wearable device, a head mounted display (HMD), or a smart speaker.

According to an embodiment, the UE 200 may include a communication interface 210, a microphone 220, a speaker 230, a display 240, a memory 250, and a processor 260. The above-listed components may be operatively or electrically connected to each other.

According to an embodiment, the communication interface 210 may be configured to be connected to an external device to transmit and receive data to and from the external device. According to an embodiment, the microphone 220 may receive sound (e.g., user utterance) and may convert the received sound into electrical signals. According to an embodiment, the speaker 230 may output electrical signals as sound (e.g., voice). According to an embodiment, the display 240 may be configured to display images or videos. According to an embodiment, the display 240 may display a graphic user interface (GUI) of an app (or an application program) to be executed.

According to an embodiment, the memory 250 may store a client module 251, a software development kit (SDK) 253, and a plurality of apps 255. The client module 251 and the SDK 253 may configure a framework (or a solution program) for performing a general-purpose function. In addition, the client module 251 or the SDK 253 may configure a framework for processing a voice input.

According to an embodiment, the plurality of apps 255 may be a program for performing a designated function. According to an embodiment, the plurality of apps 255 may include a first app 255_1 and a second app 255_3. According to an embodiment, each of the plurality of apps 255 may include a plurality of actions for performing designated functions. For example, the plurality of apps 255 may include at least one of an alarm app, a message app, or a schedule app. According to an embodiment, the plurality of apps 255 may be executed by a processor 260 to sequentially execute at least some of the plurality of actions.

According to an embodiment, the processor 260 may control the overall operation of the UE 200. For example, the processor 260 may be electrically connected to the communication interface 210, the microphone 220, the speaker 230, the display 240, and the memory 250 to perform designated operations.

According to an embodiment, the processor 260 may execute a program stored in the memory 250 to perform a designated function. For example, the processor 260 may execute at least one of the client module 251 or the SDK 253 to perform the following operation for processing a voice input. The processor 260 may control the operation of the plurality of apps 255 through, for example, the SDK 253. The following operation described as the operation of the client module 251 or the SDK 253 may be an operation by the execution of the processor 260.

According to an embodiment, the client module 251 may receive a voice input. For example, the client module 251 may generate a voice signal corresponding to a user utterance detected through the microphone 220. The client module 251 may transmit the received voice input to the intelligent server 300. According to an embodiment, the client module 251 may transmit state information of the UE 200 to the intelligent server 300 together with the received voice input. The state information may be, for example, execution state information of an app.

According to an embodiment, the client module 251 may receive a result corresponding to the received voice input. For example, the client module 251 may receive the result corresponding to the voice input from the intelligent server 300. The client module 251 may display the received result on the display 240.

According to an embodiment, the client module 251 may receive a plan corresponding to the received voice input. The client module 251 may display, on the display 240, a result obtained by executing a plurality of actions of an app according to the plan. For example, the client module 251 may sequentially display the execution results of the plurality of actions on the display. According to another example, the UE 200 may display some of the results obtained by executing the plurality of actions on the display 240.

According to an embodiment, the client module 251 may receive a request for acquiring information used for calculating a result corresponding to the voice input from the intelligent server 300. The information used for calculating the result may be, for example, state information of the UE 200. According to an embodiment, the client module 251 may transmit the used information to the intelligent server 300 in response to the request.

According to an embodiment, the client module 251 may transmit result information obtained by executing the plurality of actions according to the plan to the intelligent server 300. The intelligent server 300 may confirm that the received voice input has been correctly processed through the result information.

According to an embodiment, the client module 251 may include a voice recognition module. According to an embodiment, the client module 251 may recognize a voice input that performs a limited function through the voice recognition module. For example, the client module 251 may execute an intelligent app for processing a voice input for performing a systematic operation through a designated input (e.g., wake up).

According to an embodiment, the intelligent server 300 may receive information related to a user voice input from the UE 200 through a communication network. According to an embodiment, the intelligent server 300 may convert data related to the received voice input into text data. According to an embodiment, the intelligent server 300 may generate a plan for performing a task corresponding to the user voice input based on the text data.

According to an embodiment, the plan may be generated by an AI system. The AI system may be a rule-based system, a neural network-based system (e.g., a feedforward neural network (FNN)), or a recurrent neural network (RNN). Alternatively, the AI system may be a combination thereof or an AI system different therefrom. According to an embodiment, the plan may be selected from a set of predefined plans or may be generated in real time in response to a user request. For example, the AI system may select at least one plan from a plurality of predefined plans.

According to an embodiment, the intelligent server 300 may transmit a result obtained according to the generated plan to the UE 200, or may transmit the generated plan to the UE 200. According to an embodiment, the UE 200 may display the result obtained according to the plan on the display 240. According to an embodiment, the UE 200 may display a result obtained by executing an operation according to the plan on the display 240.

The intelligent server 300 according to an embodiment may include a front end 310, a natural language platform 320, a capsule DB 330, an execution engine 340, an end user interface 350, a management platform 360, a big data platform 370, and an analytic platform 380.

According to an embodiment, the front end 310 may receive a voice input received from the UE 200. The front end 310 may transmit a response corresponding to the voice input.

According to an embodiment, the natural language platform 320 may include an automatic speech recognition (ASR) module 321, a natural language understanding (NLU) module 323, a planner module 325, a natural language generator (NLG) module 327, and a text-to-speech (TTS) module 329.

According to an embodiment, the ASR module 321 may convert a voice input received from the UE 200 into text data. According to an embodiment, the NLU module 323 may determine user's intention by using the text data of the voice input. For example, the NLU module 323 may determine the user's intention by performing syntactic analysis or semantic analysis. According to an embodiment, the NLU module 323 may determine the meaning of a word extracted from a voice input by using linguistic features (e.g., grammatical elements) of a morpheme or phrase, and may match the determined meaning of the word to the intention, thereby determining the user's intention.

According to an embodiment, the planner module 325 may generate a plan using the intention determined by the NLU module 323 or a parameter. According to an embodiment, the planner module 325 may determine a plurality of domains required for performing a task based on the determined intention. The planner module 325 may determine a plurality of actions included in each of the plurality of domains determined based on the above-mentioned intention. According to an embodiment, the planner module 325 may determine a parameter used to execute the determined plurality of actions or a result value output by the execution of the plurality of actions. The parameter and the result value may be defined as a concept related to a designated type (or class). Thus, the plan may include the plurality of actions determined by the user's intention and a plurality of concepts. The planner module 325 may determine a relationship between the plurality of actions and the plurality of concepts in a stepwise manner (or hierarchical manner). For example, the planer module 325 may determine the execution order of the plurality of actions determined according to the user's intention based on the plurality of concepts. In other words, the planner module 325 may determine the execution order of the plurality of actions based on parameters used for the execution of the plurality of actions and results output by the execution of the plurality of actions. Accordingly, the planner module 325 may generate a plan including association information (e.g., ontology) between the plurality of actions and the plurality of concepts. The planner module 325 may generate a plan using information stored in the capsule DB 330 in which a set of the relationships between the concepts and the actions is stored.

According to an embodiment, the NLG module 327 may convert designated information into information in a text form. The information converted in the text form may be in the form of natural language utterance. The TTS module 329 according to an embodiment may convert the information in the text form into information in a voice form.

According to an embodiment, the capsule DB 330 may store information on a relationship between a plurality of concepts and a plurality of actions corresponding to a plurality of domains. For example, the capsule DB 330 may store a plurality of capsules including a plurality of action objects (or action information) and a concept object (or concept information) of the plan. According to an embodiment, the capsule DB 330 may store the plurality of capsules in the form of a concept action network (CAN). According to an embodiment, the plurality of capsules may be stored in a function registry included in the capsule DB 330.

According to an embodiment, the capsule DB 330 may include a strategy registry that stores strategy information used when a plan corresponding to a voice input is determined. The strategy information may include, when there are a plurality of plans corresponding to the voice input, reference information for determining one plan. According to an embodiment, the capsule DB 330 may include a follow-up registry that stores follow-up action information for suggesting a follow-up action to a user in a designated situation. The follow-up action may include, for example, a follow-up utterance. According to an embodiment, the capsule DB 330 may include a layout registry that stores layout information of information output through the UE 200. According to an embodiment, the capsule DB 330 may include a vocabulary registry that stores vocabulary information included in capsule information. According to an embodiment, the capsule DB 330 may include a dialogue registry that stores information on dialogue (or interaction) with a user.

According to an embodiment, the capsule DB 330 may update the stored object through a developer tool. The developer tool may include, for example, a function editor for updating the action object or the concept object. The developer tool may include a vocabulary editor for updating vocabulary. The developer tool may include a strategy editor for generating and registering a strategy for determining a plan. The developer tool may include a dialog editor for generating a conversation with a user. The developer tool may include a follow-up editor that can activate a follow-up goal and edit a follow-up utterance providing a hint. The follow-up goal may be determined based on a currently configured goal, user preferences, or an environmental condition.

According to an embodiment, the capsule DB 330 may be implemented even within the UE 200. In other words, the UE 200 may include the capsule DB 330 that stores information for determining an action corresponding to the voice input.

According to an embodiment, the execution engine 340 may obtain a result by using the generated plan. According to an embodiment, the end user interface 350 may transmit the obtained result to the UE 200. Accordingly, the UE 200 may receive the result and may provide the received result to the user. According to an embodiment, the management platform 360 may manage information used by the intelligent server 300. According to an embodiment, a big data platform 370 may collect data of a user. According to an embodiment, the analytic platform 380 may manage quality of service (QoS) of the intelligent server 300. For example, the analytic platform 380 may manage the components and processing speed (or efficiency) of the intelligent server 300.

According to an embodiment, the service server 400 may provide a designated service (e.g., food order or hotel reservation) to the UE 200. According to an embodiment, the service server 400 may be a server operated by a third party. For example, the service server 400 may include a first service server 401, a second service server 403, and/or a third service server 405 operated by different third parties. According to an embodiment, the service server 400 may provide the intelligent server 300 with information for generating a plan corresponding to the received voice input. The provided information may be stored, for example, in the capsule DB 330. In addition, the service server 400 may provide the intelligent server 300 with result information according to the plan.

In the integrated intelligence system 20 described above, the UE 200 may provide a variety of intelligent services to the user in response to a user input. The user input may include, for example, an input through a physical button, a touch input, or a voice input.

According to an embodiment, the UE 200 may provide a voice recognition service through an intelligent app (or voice recognition app) stored therein. In this case, for example, the UE 200 may recognize a user utterance or voice input received through the microphone 220 and may provide a service corresponding to the recognized voice input to the user.

According to an embodiment, the UE 200 may perform a designated operation by itself or together with the intelligent server 300 and/or the service server 400 based on the received voice input. For example, the UE 200 may execute an app corresponding to the received voice input and may perform the designated operation through the executed app.

According to an embodiment, when the UE 200 provides a service together with the intelligent server 300 and/or the service server 400, the UE 200 may use the microphone 220 to detect a user utterance, and may generate a signal (or voice data) corresponding to the detected user utterance. The UE 200 may transmit the voice data to the intelligent server 300 using the communication interface 210.

According to an embodiment, in response to the voice input received from the UE 200, the intelligent server 300 may generate a plan for performing a task corresponding to the voice input or a result obtained by executing an action according to the plan. The plan may include, for example, a plurality of actions for performing a task corresponding to a voice input of a user and a plurality of concepts related to the plurality of actions. The concept may be obtained by defining a parameter input to the execution of the plurality of actions or a result value output by the execution of the plurality of actions. The plan may include association information between the plurality of actions and the plurality of concepts.

The UE 200 according to an embodiment may receive the response using the communication interface 210. The UE 200 may output a voice signal generated inside the UE 200 to the outside using the speaker 230 or may output an image generated inside the UE 200 to the outside using the display 240.

FIG. 3 is a diagram illustrating an example in which relationship information between a concept and an action is stored in a database according to various embodiments.

The capsule DB (e.g., the capsule DB 330) of the intelligent server 300 may store a plurality of capsules in the form of a CAN 500. The capsule DB may store an action for processing a task corresponding to a voice input of a user, and a parameter used for the action in the form of a CAN. The CAN may represent a systematic relationship between the action and a concept defining the parameter used to perform the action.

The capsule DB may store a plurality of capsules (e.g., Capsule A 501 and Capsule B 502) corresponding to each of a plurality of domains (e.g., applications). According to an embodiment, one capsule (e.g., Capsule A 501) may correspond to one domain (e.g., an application). In addition, one capsule may correspond to at least one service provider (e.g., CP 1 503, CP 2 504, CP 3 505, or CP 4 506) to perform the function of the domain associated with the capsule. According to an embodiment, one capsule may include at least one or more actions 510 and at least one or more concepts 520 to perform a designated function.

According to an embodiment, the natural language platform 320 may generate a plan for performing a task corresponding to a received voice input using a capsule stored in the capsule DB. For example, the planner module 325 of the natural language platform (e.g., the natural language platform 320) may generate a plan using a capsule stored in the capsule DB. For example, a plan 507 may be generated using actions 5011 and 5013 and concepts 5012 and 5014 of Capsule A 501 and actions 5041 and concepts 5042 of Capsule B 502.

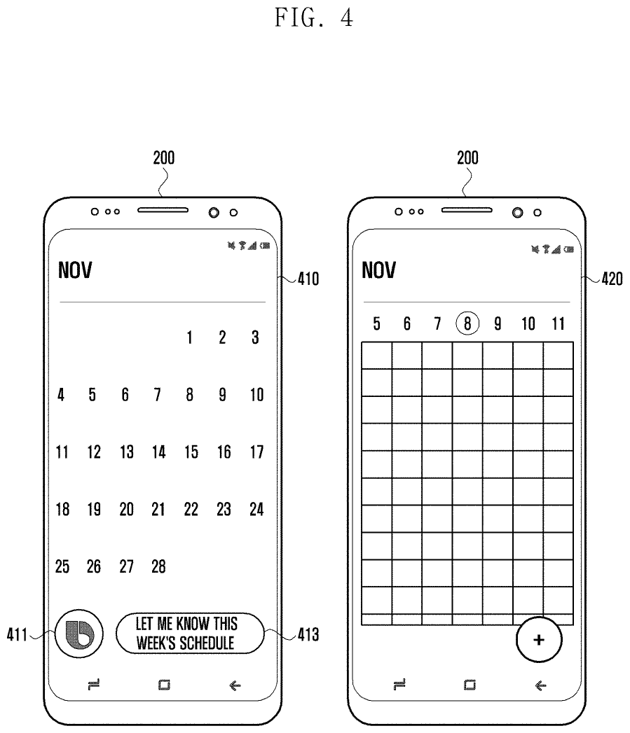

FIG. 4 is a diagram illustrating a screen in which the UE 200 processes a voice input received through an intelligent app according to various embodiments.

According to an embodiment, the UE 200 may execute an intelligent app to process a user input through the intelligent server 300.

According to an embodiment, on a screen 410, when the UE 200 recognizes a designated voice input (e.g., wake up!) or receives an input through a hardware key (e.g., a dedicated hardware key), the UE 200 may execute an intelligent app for processing the voice input. For example, the UE 200 may execute the intelligent app in a state where a schedule app is executed. According to an embodiment, the UE 200 may display an object (e.g., an icon) 411 corresponding to the intelligent app on the display 240. According to an embodiment, the UE 200 may receive a voice input by user utterance. For example, the UE 200 may receive a voice input of “let me know this week's schedule!”. According to an embodiment, the UE 200 may display, on the display 240, a user interface (UI) 413 (e.g., an input window) of an intelligent app on which text data of the received voice input is displayed.

According to an embodiment, on the display 420, the UE 200 may display a result corresponding to the received voice input on the display 240. For example, the UE 200 may receive a plan corresponding to the received user input, and may display “this week schedule” on the display 240 according to the plan.

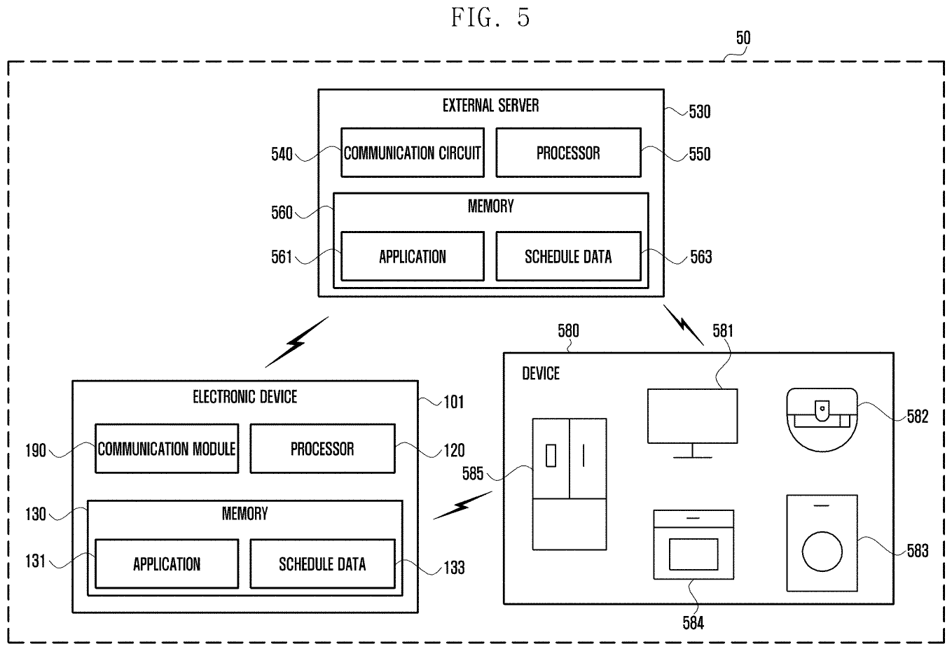

FIG. 5 is a diagram illustrating a system 50 for schedule management according to various embodiments.

According to an embodiment, FIG. 5 illustrates an example of a system architecture in which the electronic device 101 (or the UE 200 in FIG. 2) generates a schedule (e.g., a schedule related to a user {hereinafter, referred to as “user schedule”}) and/or a schedule related to a device (hereinafter, referred to as “device schedule”) based on a user input (e.g., schedule registration) using an application (e.g., a calendar application, a group (or family) calendar application, or a device calendar application) for schedule management, and provides a recommendation related to the operation (e.g., usage and/or control) of the device when the generated schedule conflicts with another schedule.

According to various embodiments, the system 50 may provide device-related schedule management that operates a corresponding device by receiving a calendar input of a user in a smart home environment. According to an embodiment, when a device schedule and a user schedule neighboring to the device schedule conflicts with each other, the system 50 may provide a variety of recommendations (e.g., function or operation of the device) related to the operation (e.g., usage and/or control) of the device, and according to an embodiment, this operation may be performed by the electronic device 101 or an external server 530.

Referring to FIG. 5, the system 50 according to various embodiments may include the electronic device 101 (or the UE 200 in FIG. 2), the external server 530, and a device 580 (or a peripheral device or an external device).

According to an embodiment, the electronic device 101 may include a processor 120, a memory 130, and a communication module 190.

According to an embodiment, the memory 130 of the electronic device 101 may store an application 131 (e.g., a calendar application) for generating and managing a schedule (e.g., a user schedule and a device schedule) related to a user and schedule data 133 based on schedule information generated by the application 131 and a user input. According to an embodiment, when a service related to a user's schedule is performed by the external server 530 operatively connected to the electronic device 101, the application 131 of the electronic device 101 may be linked with an application 561 stored in the memory 560 of the external server 530, and the schedule data 133 may be stored in the memory 560 of the external server 530.

According to an embodiment, the communication module 190 of the electronic device 101 may be a communicator including a circuit for communication processing. According to an embodiment, the communication module 190 may transmit schedule information according to a user input to the external server 530 based on the control of the processor 120. According to an embodiment, the communication module 190 may receive, from the external server 530, data such as a user interface including recommendation information related to the option of the device, information (or command) related to the control of the device, and schedule information related to multiple users. According to an embodiment, the communication module 190 may be connected to the device 580 based on at least one communication channel of a direct (e.g., wired) communication channel or a wireless communication channel, and may provide a variety of data (or command) through the connected communication channel.

According to an embodiment, the processor 120 of the electronic device 101 may execute the application 131 (e.g., a calendar application), and may receive a user input through a user interface related to the calendar application to generate a device schedule related to the device. According to an embodiment, when a device schedule (e.g., a new schedule) according to a user input and a user schedule neighboring to the device schedule conflicts with each other, the processor 120 may propose a change option associated with a device operation required time. For example, the processor 120 may propose an option of changing the operation required time of the device to match the operation completion time of the device to the user schedule.

According to an embodiment, the processor 120 may propose an option of searching for a user corresponding to an automatic completion time of a corresponding device by referring to a schedule of another user and extracting a top user according to a frequency ranking of using the corresponding device to request a task. According to an embodiment, the processor 120 may analyze schedule information of a user to generate an identification tag, and may suggest the operation of an additional device related to the identification tag. According to an embodiment, the operation of the electronic device 101 (or the processor 120) will be described with reference to the drawings to be described later.

According to various embodiments, the electronic device 101 may serve as central control equipment, a hub, an artificial intelligence device (e.g., an AI speaker), or a central server (or an integrated server) that manages the peripheral device 580 in a smart home environment.

According to an embodiment, the electronic device 101 may process an action related to schedule management based on a user input associated with an operation (e.g., mode configuration) of the electronic device 101, not a calendar application. According to an embodiment, the processor 120 of the electronic device 101 may receive schedule information (e.g., mode configuration) related to a device schedule (e.g., an operation mode of the electronic device 101) from a user. For example, a user may configure a desired mode in the electronic device 101 (e.g., a washing machine) to be used, and the processor 120 may obtain a user input associated with mode configuration as schedule information.

According to an embodiment, the processor 120 may identify whether the device schedule is related to a user and the device schedule conflicts with another schedule (e.g., an adjacent schedule) neighboring to the device schedule before executing an action associated with the device schedule (e.g., executing a configuration mode). According to an embodiment, when it is determined that a conflict occurs between the schedules, the device 580 may recommend another schedule information (e.g., another mode configuration value) associated with the device schedule.

According to an embodiment, the external server 530 may include a processor 550, a memory 560, and a communication circuit 540. According to an embodiment, the external server 530 may include, for example, a calendar management server, a service server, a device management server, or a cloud server.

According to an embodiment, the memory 560 of the external server 530 may store schedule data 563 based on schedule information generated by the application 561 based on the application 561 (e.g., calendar application) for generating and managing a user-related schedule (e.g., user schedule or device schedule) and a user input. According to an embodiment, when a user's schedule-related service is performed by the external server 530, the application 561 may be operatively linked with the application 131 stored in the memory 130 of the electronic device 101.

According to an embodiment, the communication circuit 540 of the external server 530 may be a communicator including a circuit for communication processing. According to an embodiment, the communication circuit 540 may transmit schedule information according to a user input to the electronic device 101 based on the control of the processor 550. According to an embodiment, the communication circuit 540 may transmit, to the electronic device 101, data such as a user interface including recommendation information related to the option of the device, information (or command) related to the control of the device, and schedule information related to multiple users. According to an embodiment, the communication circuit 540 may be connected to the electronic device 101 and/or the device 580 based on a wireless communication channel, and may provide a variety of data (or commands) through the connected communication channel.

According to an embodiment, when schedule management according to various embodiments is performed by the external server 530, the processor 550 of the external server 530 may perform a related operation. According to an embodiment, the processor 550 may receive schedule information from the electronic device 101, and may generate a schedule (e.g., user schedule associated with the user of the electronic device 101 or user schedule associated with the user of an accessible account) based on the received schedule information. According to an embodiment, when the schedule information includes a device schedule based on analyzed schedule information, the processor 550 may generate the device schedule.

According to an embodiment, the processor 550 may identify whether a conflict occurs between the schedules. According to an embodiment, the processor 550 may identify whether a conflict occurs between user-related other schedules (or a new schedule and an adjacent schedule (temporally) neighboring thereto), and may generate recommendation information and provide the same to the electronic device 101 when a conflict occurs therebetween. According to an embodiment, when a device schedule (e.g., a new schedule) according to a user input and a user schedule neighboring to the device schedule conflicts with each other, the processor 550 may propose a change option associated with a device operation required time. For example, the processor 550 may propose an option of changing the operation required time of the device to match the operation completion time of the device to the user schedule.

According to an embodiment, the processor 550 may propose an option of searching for a user who can respond to the automatic completion time of a corresponding device with reference to schedules of other users and extracting a top user according to a frequency ranking of using the corresponding device to request a task. According to an embodiment, the processor 550 may analyze schedule information of a user to generate an identification tag and may suggest the operation of an additional device associated with the identification tag. According to an embodiment, the operation of the external server 530 (or the processor 550) will be described with reference to the drawings to be described later.

According to various embodiments, FIG. 5 illustrates the operation of the external server 530, but the external server 530 may include a plurality of servers, for example, a calendar management server, a service server, a connection device management server, etc., and the operation of the external server 530 may be processed in a distributed manner based on the plurality of servers.

According to an embodiment, the device 580 may include various types of peripheral devices (e.g., home appliances 581, 582, 583, 584, and 585) that may be used and/or controlled by multiple users (e.g., users and/or other users). According to an embodiment, although the device 580 is schematically illustrated in FIG. 5, the device 580 may include some or all of the components of the electronic device 101 shown in FIG. 1. For example, the device 580 may be a device of the same or different type as the electronic device 101 shown in FIG. 1.

According to an embodiment, the device 580 may be connected to the electronic device 101 based on at least one communication channel of a direct (e.g., wired) communication channel or a wireless communication channel. According to an embodiment, the device 580 may be connected to the external server 530 based on a wireless communication channel. According to various embodiments, the device 580 may receive control information and/or a command from the electronic device 101 or the external server 530 and may operate based on the received control information and/or command.

According to an embodiment, the device 580 may receive schedule information (e.g., mode configuration) associated with the device schedule from the user. For example, a user may configure a desired mode in the device 580 (e.g., a washing machine) to be used, and the device 580 may acquire a user input associated with the mode configuration as the schedule information. According to an embodiment, the device 580 may identify whether the device schedule is related to a user and the device schedule and another schedule (e.g., an adjacent schedule) neighboring thereto conflict with each other before executing an action associated with the device schedule (executing the configuration mode).

According to an embodiment, the device 580 may identify whether a conflict occurs between the schedules through the external server 530. According to an embodiment, the device 580 may recommend another schedule information (e.g., another mode configuration value) associated with the device schedule when it is determined that a conflict occurs between the schedules. According to an embodiment, the device 580 may transmit schedule information associated with the device schedule to the external server 530 using a communication circuit, may receive another schedule information from the external server 530, and may provide a user with the received other schedule information.

According to an embodiment, the device 580 may be respectively connected to a server (e.g., an internal server {e.g., the electronic device 101} or the external server 530). For example, all processing operations associated with the device control according to the device schedule may be performed by a centralized control system controlled by a specific server. According to an embodiment, the specific server may include an internal server (e.g., the electronic device 101) disposed in the same space as the device 580, or the external server 530 disposed outside. For example, the internal server may be a central server and may use, for example, separate central control equipment or any one electronic device. For example, the external server may be a server existing somewhere outside (e.g., on the Internet), and may include, for example, a cloud server, an account server, a service server, a web server, and the like.

As described above, the electronic device 101 according to various embodiments may include a display and at least one processor connected to the display. The processor may acquire schedule information associated with an operation of a device from the user, may generate at least one first schedule based on the schedule information, may identify at least one second schedule stored in the calendar application, comparing time information of the first schedule with time information of the second schedule, may identify a section where the time information of the first and second schedules at least partially overlaps each other, and may output an option of changing the operation of the device associated with the first schedule based on the section where the first schedule and the second schedule overlap each other.

According to various embodiments, the processor may identify another device used in conjunction with the device of the first schedule based on the calendar application, may acquire schedule information associated with the operation of the other device, may generate at least one third schedule based on the schedule information, and may output an option including the third schedule.

According to various embodiments, when the time information of the first and second schedules partially overlaps each other, the processor may identify schedule information associated with at least one other users based on the calendar application, may select a user for the control of the device based on schedule information associated with the identified at least one other users, and may output an option of requesting the operation associated with the device from the selected user.

According to various embodiments, the processor may search for candidate users who can operate the device based on the schedule information associated with the at least one other users, and may select the user for the control of the device according to a frequency ranking using the device from the candidate users.

According to various embodiments, the calendar application may include a schedule associated with at least one device and a schedule associated with multiple users, and may be an application capable of sharing a schedule among the multiple users.

According to various embodiments, the processor may transmit the schedule information associated with the first schedule to the external server using the communication circuit, and may acquire schedule information associated with the at least one second schedule stored in the calendar application.

According to various embodiments, the processor may identify time information that does not overlap between the time information of the first schedule and the time information of the second schedule, may identify an operation mode of the device based on the identified time information, and may output an option of changing the operation required time of the device based on the operation mode.

According to various embodiments, the processor may acquire a user input associated with the above-mentioned option, and may change the time information of the first schedule when the user input is a response for changing the operation of the device, and may register the first schedule in the calendar application based on the changed time information.

According to various embodiments, when the user input is the response for changing the operation associated with the device, the processor may acquire a response of the selected other user, and may register the time information of the first schedule in the calendar application based on the response of the other user.

According to various embodiments, the user input may include at least one of a voice input or a manual input.

According to various embodiments, the processor may predict a section where time information between the schedules at least partially overlaps each other in the calendar application, using a learning model trained using an AI algorithm, and may acquire recommendation information associated with the operation of the device based on the at least partially overlapping section.

According to various embodiments, the processor may predict the section where the time information between the schedules at least partially overlaps each other in the calendar application, using a learning model trained using at least one of machine learning, neural network, genetic, deep learning, or classification algorithm as the AI algorithm, and may acquire recommendation information associated with the operation of the device based on the at least partially overlapping section.

As described above, the electronic device 101 according to various embodiments may include a communication circuit, an output device, and at least one processor connected to the communication circuit and the output device. The processor may acquire schedule information associated with an operation of the electronic device from a user, may generate a schedule based on the schedule information, may transmit the schedule information to an external server using the communication circuit, may acquire options capable of changing the operation of the electronic device associated with the schedule, may output the options using the output device, may select any one option among the options based on a user input, and may change the schedule based on the schedule information of the selected option.

According to various embodiments, operations performed by the electronic device 101 (or the UE 200 in FIG. 2) which will be descried later may be performed by at least one processor (e.g., the processor 120 in FIG. 1 or 5 or the processor 260 in FIG. 2 as at least one processor including a processing circuit) (hereinafter, referred to as “processor 120”) of the electronic device 101. According to an embodiment, the operations performed by the electronic device 101 may be stored in a memory (e.g., the memory 130 in FIG. 1 or FIG. 5), and may be executed by instructions for causing the processor 120 to operate when executed. According to various embodiments, the electronic device 101 may include a display (e.g., the display 160 in FIG. 1 or the display 240 in FIG. 2), at least one processor 120 operatively connected to the display, and a memory (e.g., or the memory 130 in FIG. 1 or FIG. 5) (hereinafter, referred to as the “memory 130”) operatively connected to the processor 120. According to an embodiment, the memory 130 may be configured to store an application (e.g., calendar application) including a user interface and schedule data (e.g., the schedule data 133 in FIG. 5).

According to various embodiments, the processor 120 may perform an operation related to constructing and providing schedules (e.g., a user schedule and a device schedule) in a calendar application using a learning model trained using an AI algorithm. According to an embodiment, the processor 120 may determine (or predict) a user's intention using the learning model trained using the AI algorithm, and may determine (or predict) a schedule according to the user's intention and information associated with the schedule. According to an embodiment, the processor 120 may perform an operation related to constructing and providing a schedule and information associated with the schedule, using at least one of machine learning, neural network, genetic, deep learning, or classification algorithm as the AI algorithm.

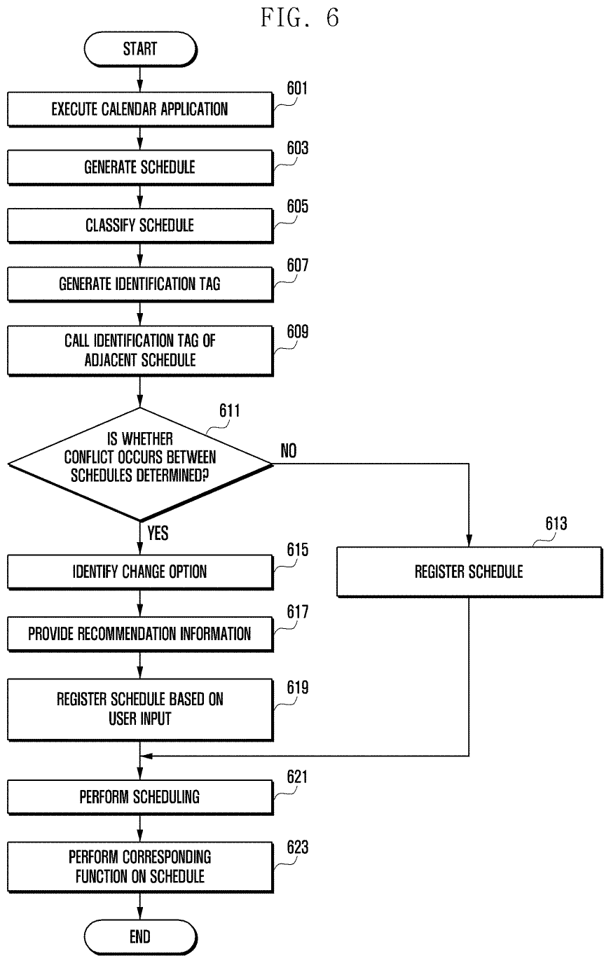

FIG. 6 is a flowchart illustrating a method of operating an electronic device according to various embodiments.

Referring to FIG. 6, in operation 601, the processor 120 may execute a calendar application. According to an embodiment, the processor 120 may receive a user input of executing the calendar application. According to an embodiment, the processor 120 may execute the calendar application based on the user input (e.g., a first user input), and may display a user interface (e.g., a calendar execution screen) related to the calendar application on a display (e.g., the display device 160 in FIG. 1).

In operation 603, the processor 120 may generate a schedule (e.g., a new schedule or a new event) (hereinafter, referred to as a “first schedule”) based on a user input (e.g., a second user input) for inputting schedule information. According to an embodiment, the schedule may include at least one piece of information related to a user schedule and/or a device schedule depending on schedule information according to a user input. According to an embodiment, the processor 120 may acquire schedule information associated with the operation of the device from a user and may generate at least one first schedule based on the acquired schedule information. According to an embodiment, the processor 120 may display the schedule information input according to the user input on a user interface and may provide the same to a user.

In operation 605, the processor 120 may classify the schedule based on the schedule information. According to an embodiment, the processor 120 may analyze the schedule information to identify a schedule type (or an event type) (e.g., a first schedule type, a second schedule type, or a third schedule type) for managing the device schedule, and may classify the schedule according to the identified schedule type. According to various embodiments, the operation of classifying the schedule by the processor 120 will be described with reference to the drawings to be descried later.

In operation 607, the processor 120 may generate an identification tag (hereinafter, referred to as a “first identification tag”) related to the device based on the schedule classification. According to an embodiment, the processor 120 may generate the first identification tag related to device control based on the schedule classification. According to various embodiments, the operation of the processor 120 generating the identification tag will be described with reference to the drawings to be described later.

In operation 609, the processor 120 may acquire (or call) an identification tag (hereinafter, referred to as “second identification tag”) of another schedule (or an adjacent schedule neighboring {e.g., temporally neighboring} to the first schedule)(hereinafter, referred to as “second schedule”) associated with the user. According to an embodiment, the processor 120 may search for the second schedule neighboring to the first schedule and may call the identification tag of the second schedule. According to an embodiment, the processor 120 may identify at least one second schedule stored in the calendar application.

In operation 611, the processor 120 may determine whether a conflict occurs between the schedules. According to an embodiment, the processor 120 may identify whether a conflict occurs between the first schedule and the second schedule based on the identification tags (e.g., the first identification tag and the second identification tag)(e.g., time-related tag information) of the first schedule (e.g., a new schedule) and the second schedule (e.g., an adjacent schedule). According to an embodiment, the processor 120 may compare time information of the first schedule with time information of the second schedule. According to an embodiment, the processor 120 may identify a section (or overlap information) where the time information between the first and second schedules at least partially overlaps (or superimposed) based on the comparison between the time information of the first schedule and the time information of the second schedule.

When the conflict does not occur between the schedules in operation 611 (or when the time information does not overlap) (e.g., “NO” of operation 611), in operation 613, the processor 120 may register the schedule (or confirm the schedule). According to an embodiment, the processor 120 may register (or confirm) the device schedule according to the first schedule as a schedule according to the schedule information.

When the conflict occurs between the schedules in operation 611 (or when the time information overlaps) (e.g., “YES” of operation 611), in operation 615, the processor 120 may identify a change option. According to an embodiment, the processor 120 may identify an operation (or a mode) in which the user can control the device (e.g., that can avoid a conflict with the user schedule) based on the schedule information, or may identify other users who can perform device-related control based on schedule information for each of the other users registered in the calendar application. According to an embodiment, when the conflict occurs between the schedules, the processor 120 may determine a schedule change option according to a conflict type and/or an inferred keyword, based on conflict type identification and/or keyword inference.

In operation 617, the processor 120 may provide recommendation information. According to an embodiment, the processor 120 may output an option capable of changing the operation of the device associated with the first schedule based on a section overlapping between the first schedule and the second schedule. According to an embodiment, the processor 120 may generate the recommendation information based on the identified at least one change option and may provide the recommendation information through at least a portion of the user interface.

According to an embodiment, the processor 120 may superimpose (or overlay) and display the recommendation information on the at least a portion of the user interface through a popup based on a popup window. According to an embodiment, the processor 120 may provide the recommendation information to the user through screen transition of the user interface. According to an embodiment, the recommendation information may include at least one piece of information related to information suggesting to change according to the change option of the operation (or mode) of the device, information suggesting to request the control of the device from appropriate another user, or information suggesting to proceed as is without a change according to the recommendation information.

In operation 619, the processor 120 may register the schedule based on a user input (e.g., a third user input) for registering a schedule. According to an embodiment, the processor 120 may identify a user input for confirming the recommendation information as the third user input. According to an embodiment, the processor 120 may identify whether to apply the recommendation information in response to the third user input.

For example, when the third user input is an input for accepting (or applying) a change in the device schedule according to the recommendation information, the processor 120 may change the device schedule (e.g., the device schedule among the first schedules) according to the changed option and may register the changed device schedule in the calendar application.

In another example, when the third user input is an input for requesting the operation of the device (e.g., management and/or control of the device) associated with the device schedule from another user according to the recommendation information, the processor 120 may transmit schedule information associated with the device schedule to the corresponding electronic device to request the control of the device from the user of the corresponding electronic device while registering the schedule information in the calendar application (e.g., without a change according to the recommendation information).

In another example, when the third user input is an input for requesting the operation of the device (management and/or control of the device) associated with the device schedule from another user according to the recommendation information, the processor 120 may acquire a response of the other user and may register the schedule information in the calendar application based on a response (e.g., an acceptance response) of the other user.

In another example, when the third user input is an input for cancelling (or rejecting) the change in the device schedule according to the recommendation information, the processor 120 may register the device schedule according to the schedule information input by the user without a change in the option.

In operation 621, the processor 120 may perform scheduling. According to an embodiment, the processor 120 may monitor an alarm and/or a control time point associated with each schedule through scheduling of at least one schedule registered in the calendar application.

In operation 623, the processor 120 may perform a corresponding function on a corresponding schedule. According to an embodiment, the processor 120 may perform a function associated with a corresponding schedule at an alarm and/or a control time point associated with a specific schedule, based on the result of the scheduling (or the result of monitoring).

For example, when the corresponding schedule is a device control according to the device schedule, the processor 120 may transmit control information to a device (e.g. a central control device)(or a device management application {e.g. smart things application}) capable of controlling the corresponding device. In another example, when the electronic device 101 can directly control a device, the processor 120 may directly transmit, to the corresponding device, a command associated with an operation control (e.g., an operation control according to a configured option) of the device. In another example, when a corresponding schedule is an alarm associated with a specific user schedule, the processor 120 may transmit, to a corresponding electronic device of a corresponding user, control information (e.g., control information for allowing an alarm {e.g., schedule information and/or alarm sound} associated with the schedule to be generated {or output}).

According to various embodiments, as described in the description with reference to FIG. 6, the processor 120 may generate the identification tags of the first schedule (e.g., a user schedule-related event) and second schedule (e.g., a device reservation configuration event) input based on the calendar application, may identify a conflict condition between the first schedule and the second schedule through the generated identification tags, and may provide, when a conflict occurs therebetween, a recommendation associated with a solution of the conflict to the user.

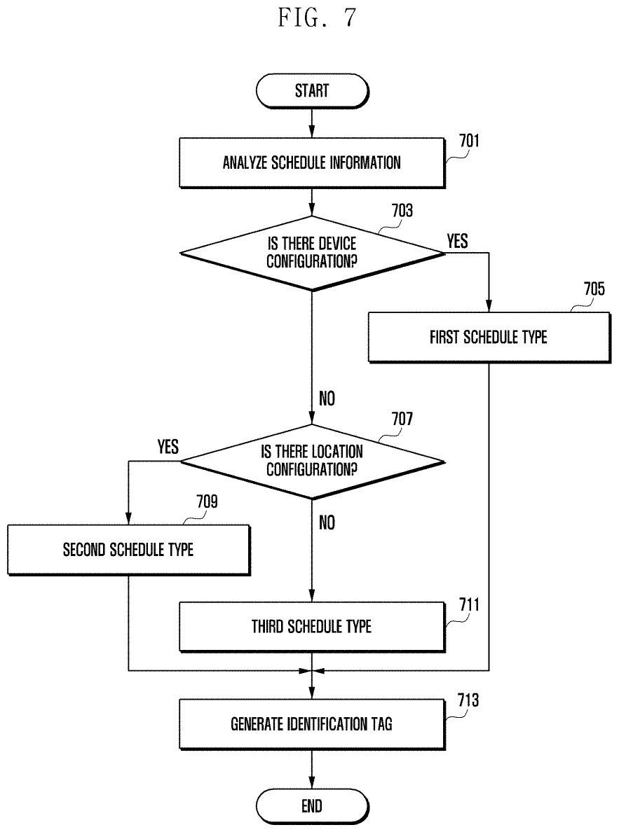

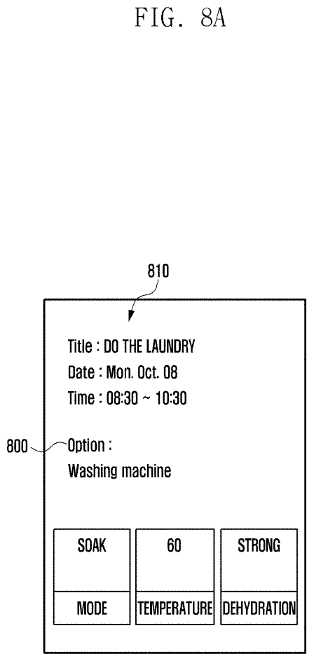

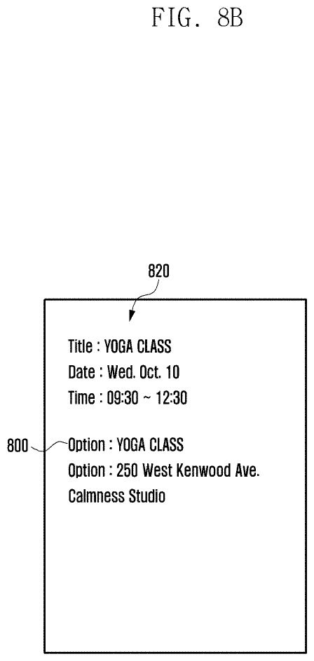

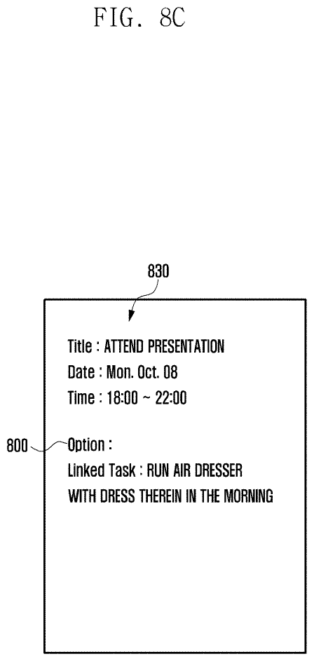

FIG. 7 is a flowchart illustrating a method of operating an electronic device according to various embodiments. FIG. 8A is a diagram illustrating an example of a schedule type according to various embodiments, FIG. 8B is a diagram illustrating an example of a schedule type according to various embodiments, and FIG. 8C is a diagram illustrating an example of a schedule type according to various embodiments.

According to an embodiment, FIG. 7 illustrates an example of operations (e.g., operations 605 and 607 in FIG. 6) of classifying a schedule for device schedule management according to a schedule type and generating an identification tag according to the classified schedule.

Referring to FIG. 7, in operation 701, the processor 120 may analyze schedule information. According to an embodiment, the processor 120 may analyze schedule information associated with an input new schedule based on a user input.

In operation 703, the processor 120 may identify whether the schedule information (e.g., option or device item) includes device-related configuration (e.g., a device name or a keyword capable of inferring the device). According to an embodiment, the processor 120 may analyze an option (or device) item of the schedule information, may analyze context (e.g., a keyword or text that the device can infer) associated with device designation information (e.g., a device name) in the option item, and may determine whether a device-related configuration exists based on the analyzed results.

When the device-related configuration is identified in the option in operation 703 (e.g., “YES” of operation 703), in operation 705, the processor 120 may classify the corresponding information into a first schedule type (e.g., the device schedule). According to an embodiment, in operation 713, the processor 120 may generate an identification tag according to the first schedule type (e.g., the device schedule). According to an embodiment, the processor 120 may analyze schedule information according to a new schedule and at least one piece of schedule information that has been previously registered in a calendar application by a user who has registered the new schedule, thereby generating an identification tag associated with the corresponding device. An example of this is shown in FIG. 8A.

Referring to FIG. 8A, the processor 120 may identify “device information (e.g., washing machine)” and “operation control information (e.g., mode (soak), temperature (60 degrees), dehydration (strong))” associated with a device with reference to an option item 800 in schedule information 810, and may classify the corresponding information into the first schedule type (e.g., device schedule) based on the identified information. According to an embodiment, the processor 120 may analyze schedule information (e.g., usage pattern) associated with the corresponding device (e.g., washing machine) in the schedule information 810 and the schedule information that has been previously registered by the corresponding user, thereby extracting a device identification tag associated with the device. For example, the processor 120 may generate an identification tag such as a user who has registered a schedule (e.g., #user A), a device (e.g., #washing machine), a device usage pattern of the user (e.g., #user A_washing pattern, main usage time for laundry_morning, #main usage day of week for laundry_Monday, #washing time_long), a device operation option (e.g., #washing option_mode-soak_temperature-60 degrees_dehydration-strong), or an associated device (e.g., #follow-up device_dryer).

When the device-related configuration is not identified in the option in operation 703 (e.g., “NO” in operation 703), in operation 707, the processor 120 may identify whether the schedule information (e.g., option) has a configuration (e.g., location designation) associated with a location (or a place). According to an embodiment, the processor 120 may analyze the option item of the schedule information, may analyze context (e.g., keyword or text) associated with the location (or the place) in the option item, and may determine whether a location-related configuration exists based on the analyzed results.

When the location-related configuration is identified in the option in operation 707 (e.g., “YES” in operation 707), in operation 709, the processor 120 may classify the corresponding information into a second schedule type (e.g., a location (or place)-based user schedule). According to an embodiment, in operation 713, the processor 120 may generate an identification tag according to the second schedule (e.g., location-based schedule). According to an embodiment, the processor 120 may analyze schedule information according to a new schedule and at least one piece of schedule information that has been previously registered in the calendar application by a user who has registered the new schedule, thereby generating the identification tag associated with the corresponding device. An example of this is shown in FIG. 8B.

Referring to FIG. 8B, the processor 120 may identify “location information (e.g., 250 West Kenwood Ave. Calmness Studio)” with reference to the option item 800 in the schedule information 820, and may classify the corresponding information into the second schedule type (e.g., location-based schedule) based on the identified information. According to an embodiment, the processor 120 may analyze schedule information (e.g., a schedule {e.g., yoga class} or a pattern associated with a location {e.g., 250 West Kenwood Ave. Calmness Studio}) associated with a corresponding location in the schedule information 820 and schedule information that has been previously registered by the corresponding user, thereby extracting a device identification tag associated with the device. For example, the processor 120 may generate an identification tag such as a user who has registered a schedule (e.g., #user A), user absence or presence (e.g., #absence#going out), a user's absence pattern (e.g., #user A_absence pattern, #absent day of week_Wednesday, #absent time_Wednesday_morning), or device usage information of a user at the time of absence (e.g., #device usage_configuration information at the time of going out).

When the location-related configuration is not identified in the option in operation 707 (e.g., “NO” in operation 707), in operation 711, the processor 120 may classify the corresponding information into a third schedule type (e.g., another (or general) schedule type other than the first schedule type and the second schedule type). According to an embodiment, in operation 713, the processor 120 may generate an identification tag according to the third schedule type. According to an embodiment, the processor 120 may analyze schedule information according to a new schedule and at least one piece of schedule information that has been previously registered in the calendar application by a user who has registered the new schedule, thereby generating the identification tag associated with the corresponding device. An example of this is shown in FIG. 8C.

Referring to FIG. 8C, the processor 120 may identify “linked task (e.g., “run air dresser with dress therein in the morning”) other than information related to a device or a location, with reference to the option item 800 in the schedule information 830, and may classify the corresponding information into the third schedule type based on the identified information. According to an embodiment, the processor 120 may analyze the schedule information 830 and schedule information (e.g., dress- and/or air dresser-related pattern) associated with the corresponding linked task in the schedule information that has been previously registered by the corresponding user, thereby extracting a device identification tag associated with the device. For example, the processor 120 may generate an identification tag such as a user who has registered a schedule (e.g., #user A), a task item (e.g., #clothing), a device (e.g., #device name_air dresser), a device usage pattern of a user (e.g., device time_October 8_morning), or a main usage operation mode (e.g. #recommended mode_classification factor_dress), user absence or presence (e.g. #going to be absent #going to go out, #absent day of week_Monday, #absent time_Monday_evening).

According to an embodiment, in FIG. 7, an example in which a newly input schedule (e.g., a new schedule) is classified into, for example, three schedule types (e.g., a first schedule type, a second schedule type, and a third schedule type), and a device-related configuration, a location-related configuration, or a task-related configuration is identified in schedule information has been described, but the disclosure is not limited thereto. For example, the schedule information may include a combination of at least two of the device-related configuration, the location-related configuration, or the task-related configuration, and the processor 120 may generate each identification tag and associated identification tag (or integrated identification tag) according to the schedule type based on the combination of the at least two of the first schedule type, the second schedule type, or the third schedule type.

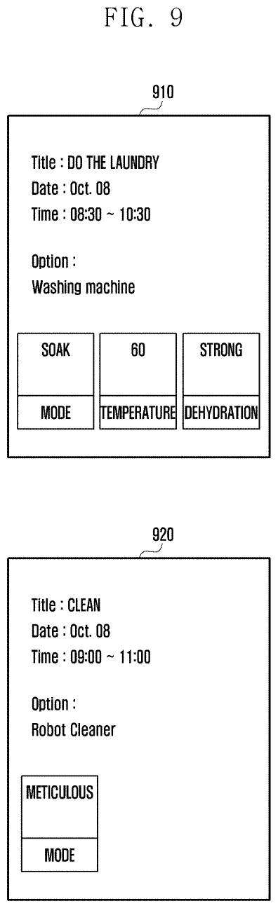

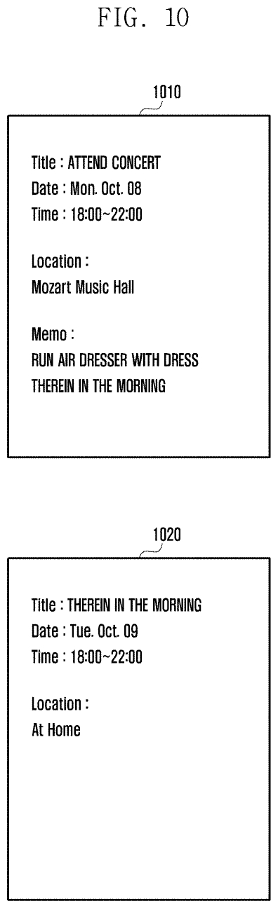

FIG. 9 is a diagram illustrating an identification tag associated with a schedule type according to various embodiments.

According to an embodiment, FIG. 9 illustrates an example of generating an identification tag associated with device control for each user of multiple users based on a calendar application. For example, FIG. 9 illustrates an example of an identification tag type associated with the first schedule type (e.g., the device schedule) as described above with reference to FIGS. 7 and 8A.

Referring to FIG. 9, the electronic device 101 may receive a user input for schedule information associated with a new schedule of a user, and may generate an identification tag associated with a device at least based on schedule information of a new schedule and schedule information of a previous schedule of the user. According to an embodiment, as shown in an example of a screen 910 (e.g., example 1), as schedule information, a user may input, for example, “washing” as title, “October 08” as date, “08:30 to 10:30” as time, “washing machine” as option (e.g., device) item, and “mode:soak, temperature: 60 degrees, dehydration:strong” as the operation mode of the washing machine. According to an embodiment, as shown in an example of a screen 920 (e.g., example 2), as schedule information, a user may input, for example, “cleaning” as title, “October 08” as date, “09:00 to 11:00” as time, “robot cleaner” as option (e.g., device) item, and “mode:meticulous” as the operation mode (or operation control information) of the robot cleaner. For example, FIG. 9 illustrates an example in which a device-related configuration (e.g., “washing machine” or “robot cleaner”) may be included in the option (or a device) item by the user.

According to an embodiment, as shown in the example (e.g., example 1) of the screen 910 or the example (e.g., example 2) of the screen 920, when the schedule information includes the device-related configuration, the electronic device 101 may classify the schedule type into the first schedule type (e.g., device schedule), and may analyze the schedule information according to the new schedule and user-related schedule information in the calendar application to extract a device identification tag. For example, the electronic device 101 may extract an associated identification tag for each identification tag type, and an example of this is shown in the following Table 1.

TABLE 1

| Identification | | |
|---|---|---|
| tag type | Example 1 | Example 2 |
| Event type | Device schedule | Device schedule |
| Device | Washing machine | Robot cleaner |
| Related user | User A | User C |
| Date and time | 2018 Oct. 10 08:30-10:30 | 2018 Oct. 8 09:00-11:00 |
| User preference | {Mode: soak} | {mode: meticulous} |
| option | {temperature: 60} | |
| | {Dehydration: strong} | |
| Extracted | wash | clean |
| keyword | | |
| Related device | {Follow-up device: | {contradiction device: |
| | Dryer} | circulator, air purifier} |
| User intervention | Y{beforehand: Y}, | N |
| required or not | {afterhand: Y} | |

FIG. 10 is a diagram illustrating an identification tag associated with a schedule type according to various embodiments.

According to an embodiment, FIG. 10 illustrates an example of generating an identification tag associated with device control for each user of multiple users based on a calendar application. For example, FIG. 10 illustrates an example of an identification tag type associated with the second schedule type (e.g., location-based user schedule) as described above with reference to FIGS. 7 and 8B.

Referring to FIG. 10, the electronic device 101 may receive a user input for schedule information associated with a new schedule of a user, and may generate an identification tag associated with a device based on schedule information of the new schedule and schedule information of a previous schedule of the user. According to an embodiment, as shown in an example of a screen 1010 (e.g., example 3), as schedule information, a user may input “attend concert” as title, “Mon. October 08” as date, “18:00 to 22:00” as time, “Mozart Music Hall” as option (e.g., location) item (e.g., option 1), and “Run air dresser with dress therein in the morning” as option (e.g., memo) item (e.g., option 2). According to an embodiment, as shown in an example (e.g., example 4) of a screen 1020, as schedule information, a user may input “family dinner” as title, “Tue. October 09” as date, “18:00 to 22:00” as time, and “at home” as option (e.g., location) item. For example, FIG. 10 illustrates an example in which a location-related configuration (e.g., “Mozart Music Hall” or “at home”) is included in option (or location) item by a user.

According to an embodiment, as shown in the example (e.g., example 3) of the screen 1010 or the example (e.g., example 4) of the screen 1020, when the location-related configuration is included in the schedule information, the electronic device 101 may classify the schedule type into the second schedule type (e.g., location-based user schedule), and may analyze the schedule information according to the new schedule and the schedule information associated with the user in the calendar application to extract a device identification tag. For example, the electronic device 101 may extract an associated identification tag for each identification tag type, and an example of this is shown in the following Table 2.

TABLE 2

| Identification | | |
|---|---|---|
| tag type | Example 3 | Example 4 |
| Event type | User schedule (based on | User schedule (based on |
| | location) | location) |
| user | User B | User A, B, C, D |
| Date and time | 2018 Oct. 8 18:00-22:00 | 2018 Oct. 9 18:00-22:00 |
| Location | Mozart Music Hall | At home |
| Extracted | Concert, dress | Family, dinner, dining room |
| keyword | | |
| Associated | Air dresser | Dining room A/C, air purifier |
| device | | |
| Priority | User B device option | User C device option |

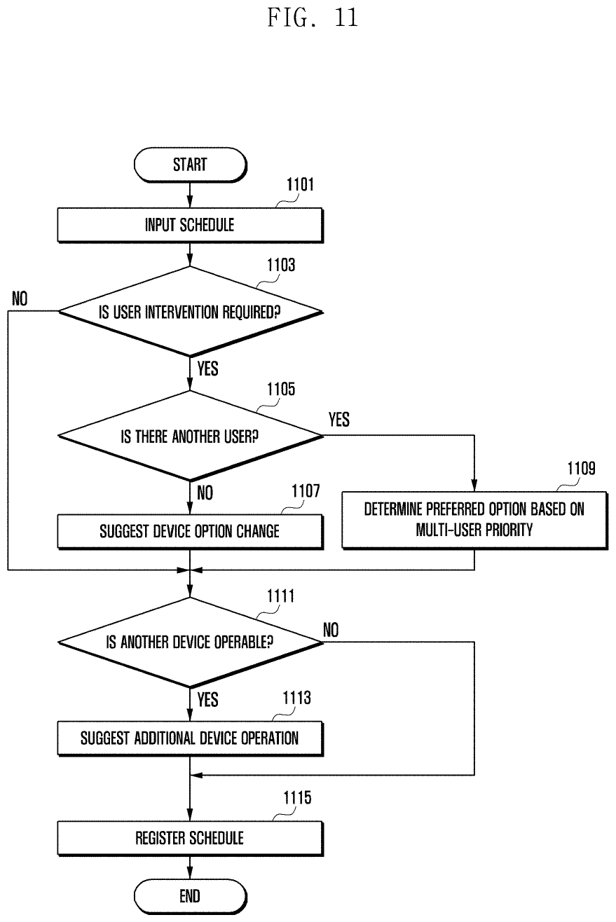

FIG. 11 is a flowchart illustrating a method of operating the electronic device 101 according to various embodiments.

According to an embodiment, FIG. 11 illustrates an example of an operation (e.g., operation 615 or operation 617 in FIG. 6) of suggesting a recommendation associated with a device schedule when a conflict occurs between a first schedule (e.g., a new schedule) newly input based on a user input and previously registered another second schedule (e.g., an adjacent schedule).

Referring to FIG. 11, in operation 1101, the processor 120 may input schedule information. According to an embodiment, the processor 120 may input schedule information associated with the new schedule based on a user input for the new schedule.

In operation 1103, the processor 120 may determine whether a device according to a device schedule requires a user intervention based on the schedule information. According to an embodiment, as shown in Table 1, the processor 120 may identify whether the device-related user intervention is required with reference to an identification tag extracted (or generated) according to the schedule type at least based on the schedule information.

When it is determined that the user intervention is not required in operation 1103 (e.g., “NO” in operation 1103), the processor 120 may proceed to operation 1103 to perform operation below operation 1113.

When it is determined that the user intervention is required in operation 1103 (e.g., “YES” in operation 1103), in operation 1105, the processor 120 may determine whether another user (or a schedule associated with multiple users) who can process the device schedule exists. According to an embodiment, when the device schedule requires the user intervention, the processor 120 may determine whether the schedule of the other user exists based on the calendar application. For example, the processor 120 may identify schedule information for each of the multiple users based on the calendar application, and may recommend an option of allowing at least one other users to manage the device schedule based on the schedule information associated with the multiple users.

According to an embodiment, the processor 120 may analyze the schedule information of the multiple users registered in the calendar application, and may identify whether the multiple users exist outside in the device schedule (e.g., time related to the device control) based on the schedule information or whether the device schedule includes a schedule corresponding to interruption prevention. For example, the processor 120 may analyze the schedule for each of the multiple users of the calendar and may identify whether another user who can control the device exists.

When the other user does not exist in operation 1105 (e.g., “NO” in operation 1105″), in operation 1107, the processor 120 may suggest a device option change. According to an embodiment, the operation of suggesting the device option change will be described with reference to the drawings to be described later.

When the other user exists in operation 1105 (e.g., “YES” in operation 1105″), in operation 1109, the processor 120 may determine a preferred option based on multi-user priority. According to an embodiment, the operation of determining and suggesting (or recommending) the preferred option based on the multi-user priority will be described with reference to the drawings to be described later.

In operation 1111, the processor 120 may determine whether another device can be operated. According to an embodiment, the processor 120 may analyze a user pattern with reference to another schedule of the user based on the calendar application, and may determine whether a suggestion associated with the operation of an additional device is made based on the user pattern. For example, the processor 120 may identify whether the additional operation of the other device is possible in conjunction with the device.

When the operation of the other device is impossible in operation 1111 (e.g., “NO” in operation 1111), in operation 1115, the processor 120 may register a corresponding schedule.

When the operation of the other device is possible in operation 1111 (e.g., “YES” in operation 1111), in operation 1113, the processor 120 may suggest the operation of the additional device, and in operation 1115, may register a corresponding schedule. According to an embodiment, the operation of suggesting the operation of the additional device will be described with reference to the drawings to be described later.

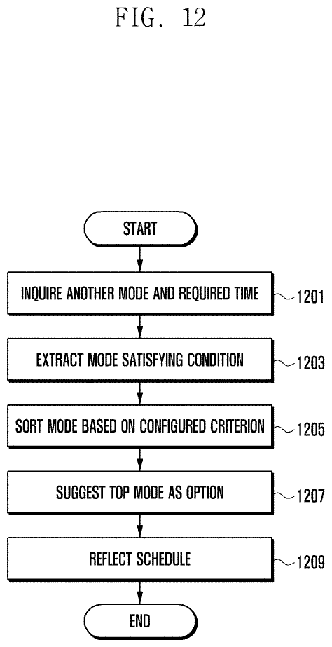

FIG. 12 is a flowchart illustrating an operation method in which the electronic device 101 provides a recommendation associated with a device schedule according to various embodiments.

According to an embodiment, FIG. 12 illustrates an example of an operation (e.g., operation 1107 in FIG. 11) of determining whether a conflict occurs between a first schedule (e.g., a new schedule) and a second schedule (e.g., an adjacent schedule) and suggesting a device option change when the conflict occurs.

Referring to FIG. 12, in operation 1201, the processor 120 may inquire another mode and required time. According to an embodiment, when a conflict occurs between a device schedule according to a new schedule and an adjacent schedule, the processor 120 may analyze various modes in which the device can operate, and may determine whether a transition to the other mode and required time associated with the device is possible based on the analyzed result.

According to an embodiment, a mode (or a user preferred option as shown in example 1 in Table 1) configured (or selected) concerning the device in the device schedule is shown in the following Table 3, and various modes in which the device can operate are shown in the following Table 4. According to an embodiment, as shown in required time item of Table 3, due to the user schedule according to the new schedule, a time (or a time limit or a reference time) at which the operation of the device should be completed may be “77 minutes”.

TABLE 3

| | | | | Required time |
|---|---|---|---|---|
| Mode | Temperature | Rinse | dehydration | (minutes) |
| Soak | 60 | 2 | Strong | 90(time limit: |
| | | | | 77 minutes) |

TABLE 4

| | | | | Required time |
|---|---|---|---|---|
| Mode | Temperature | Rinse | Dehydration | (minutes) |
| Standard | 60 | 3 | Strong | 80 |
| Standard | 40 | 3 | Strong | 70 |
| Standard | 30 | 3 | Strong | 65 |
| Quick | 30 | 2 | Middle | 45 |
| Quick | 40 | 2 | Middle | 55 |
| . . . | . . . | . . . | . . . | . . . |

In operation 1203, the processor 120 may extract a mode satisfying a condition. According to an embodiment, the processor 120 may extract a mode satisfying a condition (e.g., required time <TimeLimit (e.g.,: t<77)) until the absence of a user (e.g., a time during which a conflict with the user schedule does not occur) based on the operation time (e.g., completion time) of the device and the absent time of the user (e.g., absence start time) according to the user schedule. According to an embodiment, referring to Table 4, the processor 120 may exclude the mode (e.g., mode having the required time of 80 minutes) having the required time of 77 minutes or more among the various modes associated with the device, and may extract the mode (e.g., mode having the required time of 70, 65, 45 and 55 minutes) having the required time of less than 77 minutes as the mode to be selected.

In operation 1205, the processor 120 may sort the extracted modes. According to an embodiment, the processor 120 may sort the extracted modes according to a configured criterion (e.g., an order in which detailed options of each mode are most similar to the mode selected by the user as the device schedule). For example, the extracted modes may be sorted in descending order of the mode having a time when the required time is the closest (e.g., the required time: option having 70).

In operation 1207, the processor 120 may suggest a top mode (e.g., a mode most similar to the mode selected by the user) as a recommended option. For example, the processor 120 may suggest a top mode (e.g., mode:standard, temperature 40, rinse: 3, dehydration: strong, required time: 70) among the modes sorted as shown in Table 4, as the option.

In operation 1209, the processor 120 may reflect a corresponding schedule. According to an embodiment, the processor 120 may change the device schedule based on the user input for option suggestion.

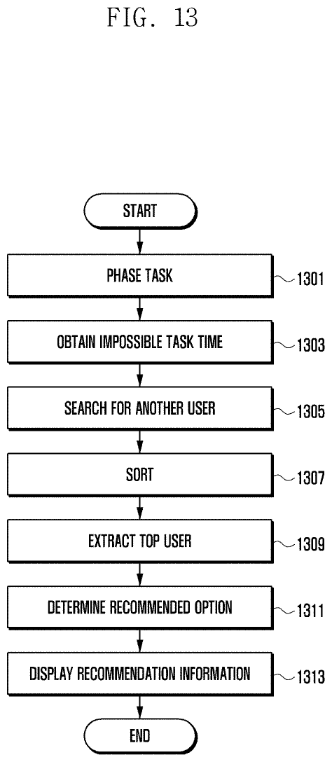

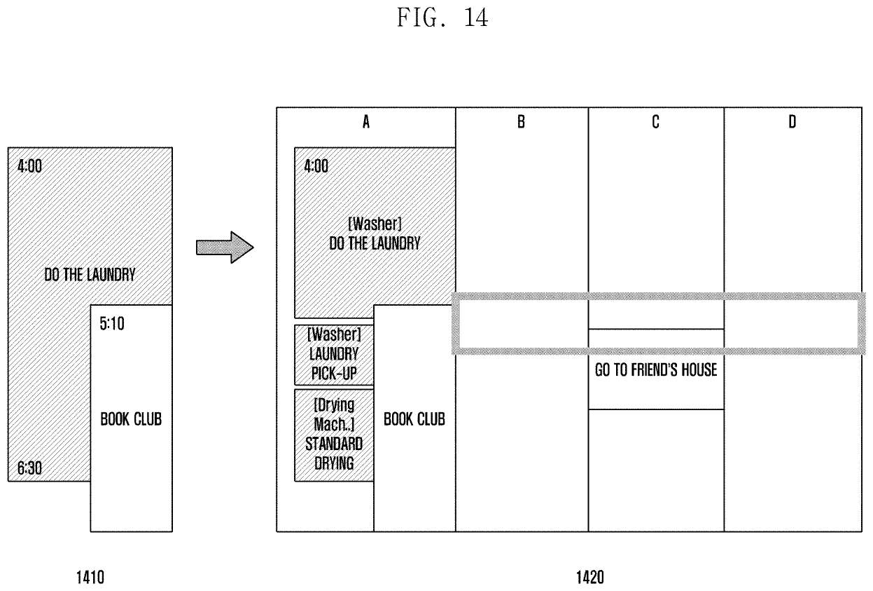

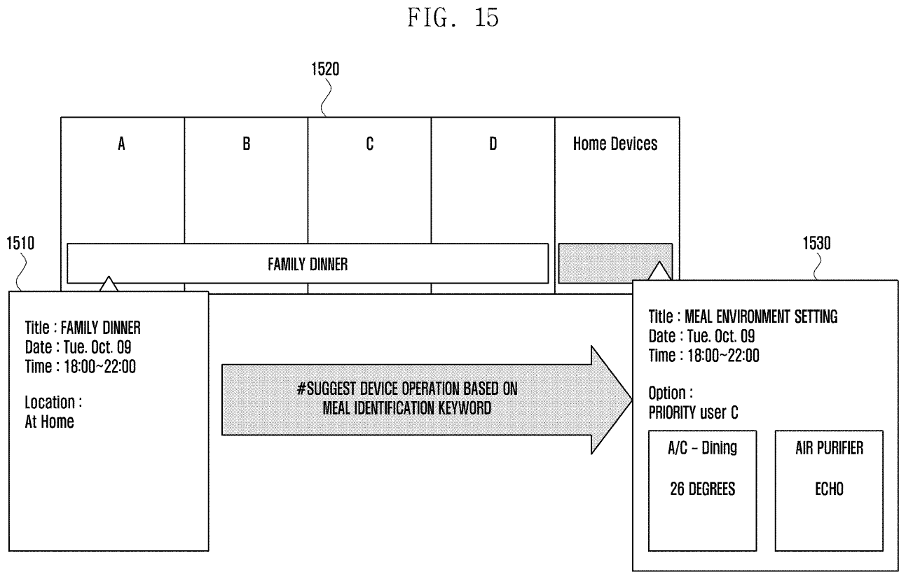

FIG. 13 is a flowchart illustrating an operation method of providing a recommendation regarding a device schedule in the electronic device 101 according to various embodiments, and FIG. 14 is a diagram illustrating an operation of separating a task in the electronic device 101 according to various embodiments.

According to an embodiment, FIGS. 13 and 14 illustrate an example of an operation (e.g., operation 1109 in FIG. 11) of determining whether a conflict occurs between the identification tags of a first schedule (e.g., a new schedule) and a second schedule (e.g., an adjacent schedule) and determining and suggesting a preferred option with reference to multi-user priority when the conflict occurs.

Referring to FIG. 13, in operation 1301, the processor 120 may phase tasks. According to an embodiment, when a conflict occurs between a device schedule according to a new schedule and an adjacent schedule and multiple users exist in a calendar application, the processor 120 may phase (e.g., task separation) tasks of the device schedule in the calendar application.

For example, referring to FIG. 14, as illustrated in element 1410, a time associated with a schedule “washing” according to the device schedule of a user (e.g., user A) is “4:00 to 6:30” and a time associated with a schedule “book club” according to the user schedule of the user (e.g., user A) is “5:10”. Here, the schedule “washing” and the schedule “book club” may conflict with each other starting from “5:10”. According to an embodiment, when a conflict occurs, the processor 120 may separate and phase the respective tasks according to the device schedule. For example, referring to FIG. 14, as illustrated in element 1420, a schedule good for washing of “4:00 to 6:30” may be phased (or separated) into, for example, a first task (e.g., washer: during washing), a second task (e.g., washer: laundry pickup), and a third task (e.g., drying machine: standard drying).

In operation 1303, the processor 120 may obtain a task time for which device control by the user (e.g., user A) is impossible. According to an embodiment, the processor 120 may obtain a task conflicting with the user schedule and a task time according thereto in the first task, the second task, and the third task according to the task phase. According to an embodiment, in an example of an element 1420 in FIG. 14, there may be a conflict at some time of the first task and at all times of the second task and the third task, and the processor 120 may identify an impossible task time based on some time of the first task and all times of the second task and the third task.

In operation 1305, the processor 120 may search for another user who can control the device at a task time when device control by the user (e.g., user A) is impossible. According to an embodiment, as illustrated in element 1420 of FIG. 14, schedules of user A, user B, user C, and user D exist in the calendar application, and the device schedule and the user schedule conflict of the user A conflict with each other. According to an embodiment, the processor 120 may analyze schedule information of the other users (e.g., user B, user C, and user D) registered in the calendar application, and may analyze each schedule state (or current status) of the other users based on the schedule information. According to an embodiment, the processor 120 may search for another user (or a user who does not have a schedule conflict) that can control the device from the schedules and the device schedules of the other users (e.g., a time related to device control). According to an embodiment, in element 1420, the user B and the user D may be the user who can control device.

In operation 1307, the processor 120 may sort the other searched users. According to an embodiment, the processor 120 may sort the searched users according to a configured criterion (e.g., device usage frequency for each user). According to an embodiment, as shown in Table 5 below, priority may be configured based on the frequency of use for each user for each device, and the processor 120 may sort the users in descending order of users with higher frequency of use associated with the device.

For example, referring to Table 5, as to the usage frequency of the device (e.g., washing machine) according to the device schedule, the user A, the user C, the user B, and the user D may be sorted in the descending order. For example, as to the device (e.g., washing machine), the priority may be determined in order of the user A, the user C, the user B, and the user D.

TABLE 5

| Device | 1^{st} priority | 2^{nd} priority | 3^{rd} priority | 4^{th} priority |
|---|---|---|---|---|
| Washing machine | A | C | B | D |
| Dryer | A | C | B | D |
| Dish washer | B | A | C | D |
| Air conditioner | D | B | A | C |
| . . . | . . . | . . . | . . . | . . . |

In operation 1309, the processor 120 may extract a top user. According to an embodiment, referring to element 1420 of FIG. 14, as to the device (e.g., washing machine), the user C among the other users (e.g., user B, user C, and user D) except the user A may have the highest priority, but in case of the user C, some schedules of the user C conflict with the device schedule. According to an embodiment, the processor 120 may exclude the user C from the target users who can control the device, and may extract the user B having the second highest priority as a top user.

In operation 1311, the processor 120 may determine an option of requesting a task from the top user as a recommended option. For example, the processor 120 may determine and suggest an option of requesting (requesting device control) a corresponding task from the user B extracted as the top user, as the recommended option.

In operation 1313, the processor 120 may provide recommendation information based on the recommended option to the user. According to an embodiment, the processor 120 may display, on a display (e.g., the display device 160 in FIG. 1), recommendation information for requesting a corresponding task from the user B.

According to an embodiment, the processor 120 may perform an operation of suggesting an option of suggesting the task from the user B extracted as the top user and transmitting a request (e.g., a device management request according to device schedule) associated with the recommendation information to the user B (or the electronic device of the user B) through a communication module (e.g., the communication module 190 in FIG. 1) based on a user input (e.g., acceptance) associated with the suggested option. According to an embodiment, the processor 120 may perform an operation of receiving a response of acceptance or rejection from the user B and further suggesting an additional option associated with the device schedule based on the received response. An example of this will be described with reference to the drawings to be described later.

FIG. 15 is a diagram illustrating an operation of providing a recommendation regarding a device in the electronic device 101 according to various embodiments.

According to an embodiment, FIG. 15 illustrates an example of an operation (e.g., operation 1113 in FIG. 11) of suggesting an additionally operable additional device in conjunction with a corresponding device other than a device according to the device schedule.

Referring to FIG. 15, as illustrated in element 1510, a user (e.g., user A, user B, user C, or user D) may register a schedule associated with “family dinner”, and the electronic device 101 may generate and register a common user schedule (e.g., family dinner) for multiple users in a calendar application as illustrated in element 1520.

According to an embodiment, as illustrated in element 1510, when the user schedule is registered, the electronic device 101 may analyze schedule information associated with the schedule to thereby infer (or extract) an identification keyword (or identification tag). According to an embodiment, the electronic device 101 may suggest an additional device in conjunction with the user schedule, and for this, may identify the identification keyword based on the schedule information.

According to an embodiment, the identification keyword may be defined for each predefined category as shown in Table 6 below. According to various embodiments, the identification keyword may be defined in advance and provided, and may be defined by individual addition for each user. According to an embodiment, the identification keyword may be automatically added using a learning model trained using an AI algorithm.

TABLE 6

| Category | |
|---|---|
| (classification) | Identification keyword |
| Sound | #movie #study #class #sleep |
| Temperature | #movie #meal #kids #invitation #sleep #travel #exercise |
| | #illness #autumn colors #first snowing #rainy season |
| Security | #invitation #delivery service #visit #sitter #travel |
| | #vacation #announcement |
| Cooperation | #meal #cooking #kids #invitation #travel #exercise |
| Illuminance | #movie #invitation #party |
| Purifying | #travel #exercise #kids #yoga #night #concert |
| | #performance |
| Remark for | Defined in advance, and automatic addition by individual |
| reference | addition of user or AI is possible |

According to an embodiment, the electronic device 101 may infer identification keywords such as “#meal” and “#cooking” from the schedule information as illustrated in element 1510, and may identify categories of “temperature” and “cooperation” based on the identification keywords. For example, the electronic device 101 may identify the categories including the inferred identification keywords. According to an embodiment, a device that can be operated for each category based on the identification keywords may be configured (or mapped). According to an embodiment, the electronic device 101 may provide, to the user, at least one device (or a device list) conforming to the category (or condition) according to the identification keyword, and may provide, to the user, a user interface associated with the operation of the device.

According to an embodiment, the electronic device 101 may generate and provide an associated device schedule as illustrated in element 1530 in association with the user schedule of element 1510. For example, the electronic device 101 may identify “air purifying” and “temperature control” as the device function conforming to the identification keyword (e.g., #meal) inferred in association with “family dinner”, and may suggest a corresponding device (e.g., air purifier or air conditioner) as an additional device. For example, the electronic device 101 may suggest the device operation based on the identification keyword (e.g., #meal). According to an embodiment, the electronic device 101 may further register the device schedule in association with the user schedule in response to a user input for the suggestion of operation of the additional device. For example, as illustrated in element 1520, in association with the user schedule (e.g., family dinner) registered in the calendar application, it is possible to further register the device schedule (e.g., meal environment setting) at a corresponding time.

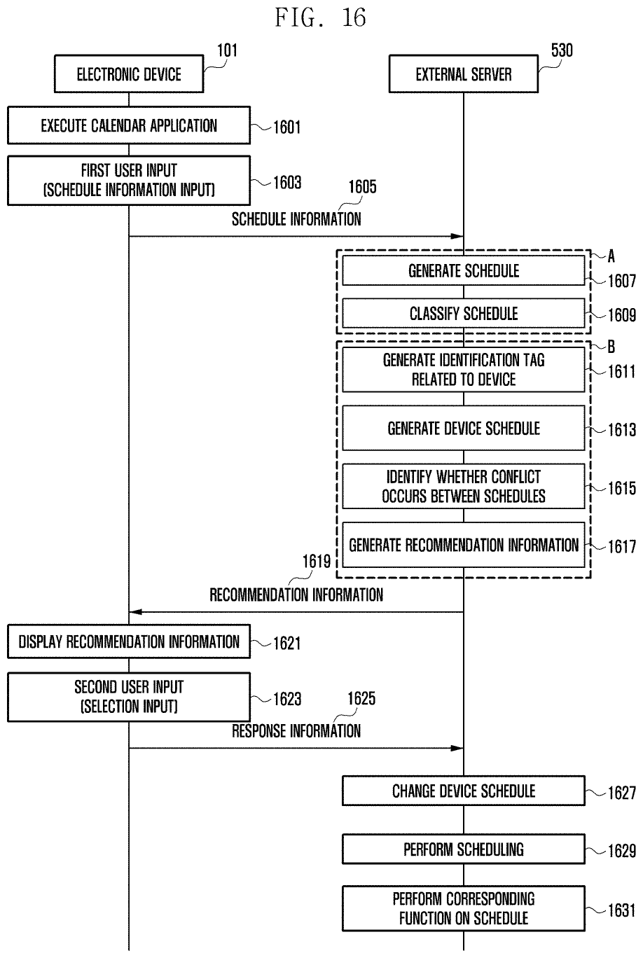

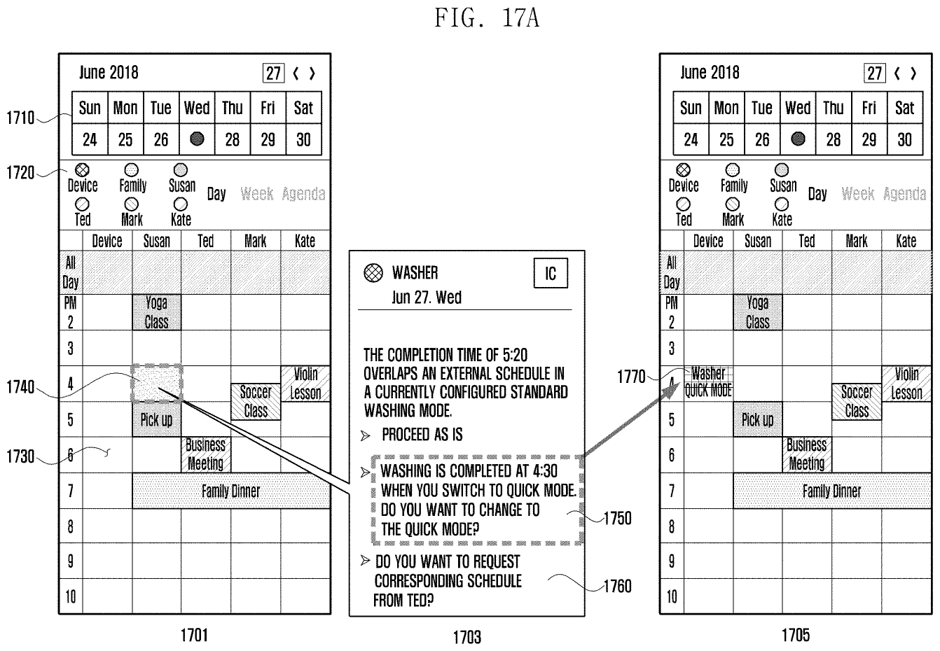

According to various embodiments, management control of the device schedule may be performed by the electronic device 101 as described above. The various embodiments are not limited thereto, and management control of the device schedule may be performed by the electronic device 101 and the external server 530. An example of this is shown in FIG. 16.

FIG. 16 is a diagram illustrating an operation between the electronic device 101 and the external server 530 according to various embodiments.

According to an embodiment, operations performed by the electronic device 101 may be stored in at least one processor 120 (e.g., at least one processor including a processing circuit) or the memory 130 of the electronic device 101, and may be executed by instructions for causing the processor 120 to be operated when executed. According to an embodiment, operations performed by the external server 530 may be stored in at least one processor 550 (e.g., at least one processor including a processing circuit) or the memory 560 of the external server 530, and may be executed by instructions for causing the processor 550 to be operated when executed.

Referring to FIG. 16, in operation 1601, the electronic device 101 may execute a calendar application. According to an embodiment, the electronic device 101 may receive a user input for executing the calendar application. According to an embodiment, the electronic device 101 may execute the calendar application based on the user input, and may display, on a display, a user interface related to the calendar application (e.g., a calendar execution screen) (e.g., the display device 160 of FIG. 1).

In operation 1603, the electronic device 101 may receive a user input (hereinafter, referred to as a “first user input”) for inputting schedule information based on the user interface.

In operation 1605, the electronic device 101 may transmit the input schedule information to the external server 530 based on the first user input. According to an embodiment, the electronic device 101 may display the schedule information input according to the first user input on the user interface and may provide the same to the user.

In operation 1607, the external server 530 may generate a schedule. According to an embodiment, the external server 530 may receive the schedule information from the electronic device 101, and may generate the schedule (e.g., a user schedule associated with the user of the electronic device 101 or a user schedule associated with the user of an accessible account) based on the received schedule information. According to an embodiment, when the schedule information is the device schedule based on analyzed schedule information, the external server 530 may not perform operation 1607 and omit the same.

In operation 1609, the external server 530 may classify the schedule based on the schedule information. According to an embodiment, the external server 530 may analyze the schedule information to identify a schedule type (or event type) (e.g., a first schedule type, a second schedule type, or a third schedule type) for managing the device schedule, and may classify the schedule according to the identified schedule type. According to an embodiment, the operation of classifying the schedule of the external server 530 may be performed to correspond to the operation of classifying the schedule of the electronic device 101 as described in the description of the electronic device 101.

In operation 1611, the external server 530 may generate an identification tag associated with the device based on the schedule classification. According to an embodiment, the operation of generating the identification tag of the external server 530 may be performed to correspond to the operation of generating the identification tag of the electronic device 101 as described in the description of the electronic device 101.

In operation 1613, the external server 530 may generate the device schedule. According to an embodiment, the external server 530 may identify at least one device to be scheduled based on the identification tag, and may generate a schedule related to the identified device based on the identification tag.

In operation 1615, external server 530 may identify whether a conflict occurs between the schedules. According to an embodiment, the external server 530 may call the identification tag of another schedule (or an adjacent schedule (e.g., temporally) neighboring to the first schedule) (hereinafter, referred to as “second schedule”) associated with the user. According to an embodiment, the external server 530 may search for the second schedule neighboring to the first schedule and may call the identification tag of the second schedule. According to an embodiment, the external server 530 may identify whether a conflict occurs between the identification tags (e.g., tag information associated with time) of the first schedule and the second schedule (e.g., whether a conflict occurs based on time) based on the identification tags (e.g., tag information associated with time) of the first schedule (e.g., a new schedule) and the second schedule (e.g., an adjacent schedule). According to an embodiment, the operation of identifying whether a conflict occurs between the schedules of the external server 530 may be performed to correspond to the operation of identifying whether a conflict occurs between the schedules of the electronic device 101 as described in the description of the electronic device 101.

In operation 1617, the external server 530 may generate recommendation information. According to an embodiment, the external server 530 may identify a change option associated with the device when a conflict occurs between the schedules. According to an embodiment, the external server 530 may identify an operation (or mode) in which the user can control the device (e.g., can avoid a conflict with the user schedule) based on the schedule information, or may identify other users who can perform device-related control based on the schedule information for each of the other users registered in the calendar application.

According to an embodiment, when a conflict occurs between the schedules, the external server 530 may determine a schedule change option according to a conflict type and/or an inferred keyword based on conflict type identification and/or keyword inference. According to an embodiment, the external server 530 may generate recommendation information based on the change option according to the determination result. According to an embodiment, the operation of generating the recommendation information of the external server 530 may be performed to correspond to the operation of recommending the change option as described in the description of the electronic device 101.

In operation 1619, the external server 530 may provide the recommendation information to the electronic device 101. According to an embodiment, the external server 530 may transmit the recommendation information to the electronic device 101 through the communication circuit 540.

In operation 1621, the electronic device 101 may display the recommendation information on a display (e.g., the display device 160 of FIG. 1 and the display 240 of FIG. 2). According to an embodiment, the electronic device 101 may receive the recommendation information from the external server 201 through the communication module 190 and may superimpose (or overlay) the received recommendation information on at least a portion of the user interface and may display the same through superimposition or pop-up.

In operation 1623, the electronic device 101 may receive a user input (hereinafter, referred to as a “second user input”) for confirming the recommendation information. According to an embodiment, the electronic device 101 may identify whether to apply the recommendation information in response to the second user input. For example, the electronic device 101 may identify whether the second user input accepts (or applies) or cancels a change in the device schedule according to the recommendation information. According to an embodiment, it is assumed that the second user input is an input of accepting (or applying) the change in the device schedule.

In operation 1625, the electronic device 101 may transmit response information to the external server 530 based on the second user input. According to an embodiment, the electronic device 101 may transmit response information (e.g., an ACK signal) requesting to change (or apply) the device schedule according to the change option based on the second user input, to the external server 530 through the communication module 190.

In operation 1627, the external server 530 may change the device schedule. According to an embodiment, the external server 530 may receive the response information from the electronic device 101 through the communication circuit 540. According to an embodiment, when the response information is response information requesting the change (or application) in the device schedule, the external server 530 may change and apply the device schedule according to the recommended change option. According to an embodiment, the change operation according to the recommended change option may include, for example, an option of requesting the operation (e.g., management and/or control of the device) of the device associated with the device schedule from another user, and an operation in which the external server 530 transmits a request related to the device schedule from the corresponding other electronic device.

In operation 1629, the external server 530 may perform scheduling. According to an embodiment, the external server 530 may monitor an alarm and/or a control time point associated with each schedule through scheduling of the schedules registered in the calendar application.

In operation 1631, the external server 530 may perform a corresponding function on the schedule. According to an embodiment, the external server 530 may perform a function related to the schedule at an alarm and/or a control time point related to the specific schedule, based on the result of the scheduling (or the result of monitoring). For example, when the corresponding schedule is a device control based on the device schedule, the external server 530 may transmit control information to a device (e.g., the electronic device 101 or a central control device)(or device management application {e.g., smart thing application} of the corresponding electronic device) that can control the corresponding device. In another example, when the external server 530 can directly control the device, the external server 530 may transmit, to the corresponding device, a command related to the operation control (e.g., operation control according to a configured option) of the device. In another example, when the corresponding schedule is an alarm associated with a specific user schedule, the external server 530 may transmit, to the electronic device (e.g., the electronic device 101) of the corresponding user, control information (e.g., control information for generating (or output) an alarm {e.g., schedule information and/or alarm sound} associated with the schedule).

According to various embodiments, in FIG. 16, the operation of the external server 530 is illustrated, but the external server 530 may include a plurality of servers, for example, a calendar management server, a service server, or a connection device management server, and the operation of the external server 530 may be distributed and processed based on the plurality of servers. For example, in an example of FIG. 16, operation A (e.g., operations 1607 to 1609) corresponding to the operation of classifying the schedule may be processed by the calendar management server, operation B (e.g., operations 1611 to 1619) corresponding to the operation of providing recommendation information may be processed by the service server, and operations 1627 to 1631 corresponding to the control operation associated with the device according to scheduling may be processed by the connection device management server.

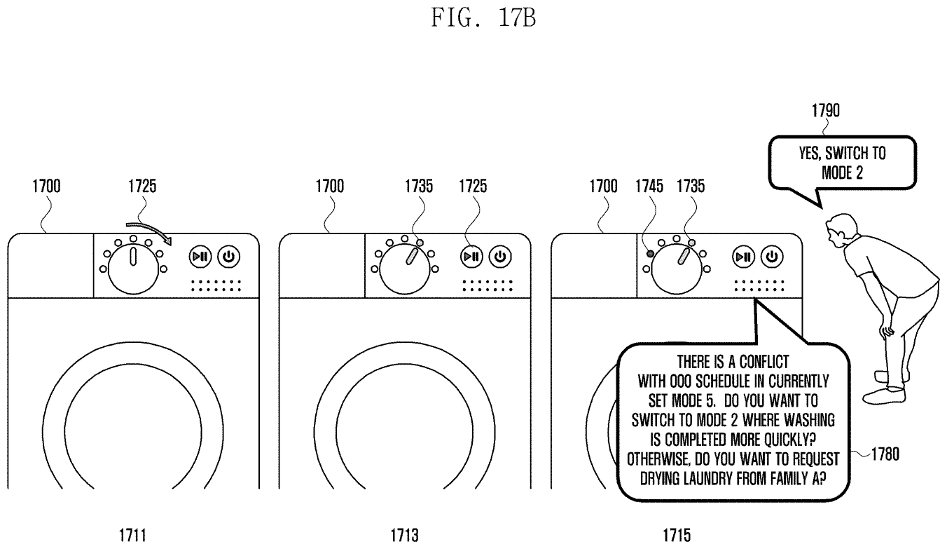

FIG. 17A is a diagram illustrating an example in which a user interface is provided according to various embodiments.

According to an embodiment, FIG. 17A illustrates an example of recommending a detailed function and device operation of a device based on a multi-user schedule.

As illustrated in FIG. 17A, a user interface of a calendar application according to various embodiments may register and manage a schedule associated with multiple users and a device for each of the multiple users.

According to an embodiment, referring to an example of a screen 1701, the user interface may include a first region 1710 for designating (or confirming) a date associated with a schedule, a second region 1720 for providing related information capable of identifying a user or a device associated with the schedule, and a third region 1730 for providing schedule information for each user and inputting the schedule of the user.

According to an embodiment, the second region 1720 may provide related information based on various objects for classification of user schedules for multiple users (e.g., a first user (“Susan”), a second user (“Ted”), a third user (“Mark”), and a fourth user (“Kate”)) and for ease of classification related to the device schedule (e.g., “Device”) by the user. According to an embodiment, the second region 1720 may classify schedules for each of multiple users and for each device into different colors and may provide the ease of user classification of the schedule for each user and/or the schedule associated with the device for each user.

According to an embodiment, in an example of a screen 1701, the user (e.g., the first user (“Susan”)) may generate a reservation schedule for washing in an input region (e.g., a region 1740) for a new schedule among the schedule regions of the user in order to receive a recommendation associated with the device based on the schedule of the user. For example, the user may input schedule information associated with washing by selecting the region 1740.

According to an embodiment, when receiving an input related to the schedule information, the electronic device 101 may analyze the input schedule information (e.g., schedule information of “Susan”), and may determine whether there is information (e.g., identification tag) that conflicts between the device schedule and the user schedule (e.g., the user schedule of “Susan”). For example, the electronic device 101 may acquire first schedule information (e.g., yoga class schedule of PM 2:00 to PM 3:00 and pick-up schedule of PM 5:00 to PM 6:00) (e.g., adjacent schedule) associated with the user based on the schedule region of the user, may acquire second schedule information (e.g., standard washing mode schedule of device (e.g., washing machine) from PM 4:00) associated with the device input through the region 1740, and may determine whether a conflict occurs between the first schedule information and the second schedule information. According to an embodiment, an example in which the standard washing mode of the washing machine requires one hour 20 minutes (e.g., washing completion time PM 5:20) will be described. In this case, a portion (e.g., PM 5:00 to PM 5:20) of the pick-up schedule of PM 5:00 to PM 6:00 in the first schedule information may conflict with a portion (e.g., PM 5:00 to PM 5:20) of the second schedule information. For example, some of the device schedules may conflict with each other for a time corresponding to the absence of the user.

According to an embodiment, when the device schedule (e.g., new schedule) and the user schedule (e.g., adjacent schedule) conflict with each other, the electronic device 101 may inform the user of the conflict between the schedules and may provide recommendation information associated with the change option of the device. For example, the electronic device 101 may provide recommendation information through at least a partial region overlap (or pop-up) or screen switching on the user interface as shown in the example of the screen 1703.

According to an embodiment, as shown in the example of the screen 1703, the electronic device 101 may provide information related to a schedule conflict (e.g., the completion time of 5:20 overlaps an external schedule in a currently configured standard washing mode) and at least one change option (e.g., a first option (e.g., proceed as is), a second option 1750, a third option 1760).

According to an embodiment, the second option 1750 is an option of suggesting to change the operation mode of the device to prevent a conflict between the user schedule and the device schedule in consideration of the schedule of the user, and may include an option of suggesting a change in the operation mode of the device that can avoid a conflict, for example, “washing is completed at 4:30 when you switch to quick mode. Do you want to change to the quick mode?”.

According to an embodiment, the third option 1760 is an option of suggesting to request device management from another user registered in the calendar application in consideration of the schedule of the other user, and may include an option of suggesting to request device management from another user, for example, “Do you want to request corresponding schedule from the second user (“Ted”)?”. In the example of FIG. 17A, a user may select the second option 1750.

According to an embodiment, the electronic device 101 may change the device schedule (e.g., change the operation mode of the device according to the recommended option {e.g., standard washing mode->quick mode}) based on a user input for selecting the second option 1750, and may apply (or reflect) the changed device schedule to the calendar application. According to an embodiment, as shown in the example of the screen 1705, the electronic device 101 may generate a region (e.g., a region 1770) corresponding to the changed device schedule among the device schedule regions in the calendar application. For example, the electronic device 101 may change a configuration value to the quick mode and may reflect the changed information on the device schedule to display the same. According to an embodiment, when generating and displaying the device schedule, the electronic device 101 may classify and display device operation-related users (or a person in charge {e.g., the first user (“Susan”)}) based on colors.

FIG. 17B is a diagram illustrating an example of changing the operation of a device according to various embodiments.

According to an embodiment, FIG. 17B illustrates an example in which a user directly registers a device schedule associated with a device 1700 (e.g., washing machine) that the user desires to use (e.g., to generate a device schedule) through the corresponding device 1700 other than the calendar application. According to an embodiment, FIG. 17B illustrates an example of outputting an option associated with the operation of the device based on time information between a device schedule (e.g., a first schedule) based on schedule information (e.g., an operation mode) associated with the operation of the device 1700 and at least one user schedule (e.g., a second schedule) stored in the calendar application.

Referring to FIG. 17B, in operation 1711, a user may configure a desired mode in the device 1700 desired to be used. For example, the user may input an operation mode associated with schedule information in the device 1700. According to an embodiment, the user may configure the operation mode of the device 1700 as a first mode 1735 (e.g., a mode 5) based on a user input 1725 for operating an operation panel associated with mode configuration of the device 1700 as shown in operation 1713.

According to an embodiment, the device 1700 may receive a user input 1725 for inputting schedule information (e.g., information associated with the configuration of the first mode 1735)(hereinafter, referred to as “schedule information 1735”) associated with the device operation from the user. According to an embodiment, the device 1700 may configure the mode (e.g., washing mode) of the device 1700 as the first mode based on the schedule information 1735. For example, the device 1700 may generate a first schedule (e.g., a device schedule) that operates in the first mode based on the schedule information 1735.

According to an embodiment, the user may input the schedule information 1735 related to the device 1700, and may allow the device 1700 to start (or perform a reservation) the first schedule according to the schedule information 1735 based on the user input 1745. According to an embodiment, the device 1700 may receive the user input 1745 for starting the first schedule, and may perform (or reserved schedule management) the first schedule according to the schedule information 1735 based on the user input 1745.

According to various embodiments, before starting the first schedule (e.g., executing a washing mode configured by the user), the device 1700 may identify a section (or overlap information) in which time information between the first schedule and at least one second schedule (e.g., a user schedule neighboring to the first schedule) stored in the calendar application at least partially overlaps (or superimposed) based on the at least one second schedule. According to an embodiment, the identifying of the section in which the time information between the first schedule and the second schedule at least partially overlaps may be performed through, for example, the device 1700 or the external server 530.

According to an embodiment, the device 1700 may identify schedule information associated with the at least one second schedule stored in the calendar application before executing the first schedule. According to an embodiment, before executing the first schedule, the device 1700 may be connected to the external server 530 based on a configured (or accessible) account to access the calendar application, and may receive the schedule information associated with the second schedule from the external server 530.

According to an embodiment, the device 1700 may identify the time information of the first schedule and the time information of the second schedule based on the schedule information 1735 of the first schedule and the schedule information of the second schedule, and may compare the time information between the first schedule and the second schedule. According to an embodiment, the device 1700 may identify whether there is a section (e.g., a section where time information conflicts with each other {or overlap information}) which at least partially overlaps between the first schedule and the second schedule. For example, the device 1700 may identify whether a conflict occurs between the schedules at least based on the overlap information.

According to an embodiment, when there is the section where the time information between the first schedule and the second schedule at least partially overlap each other (e.g., when a conflict occurs), in operation 1715, the device 1700 may output an option 1780 capable of changing the operation of the device related to the first schedule. For example, the device 1700 may output at least one option 1780 such as “There is a conflict with OOO schedule in currently set mode 5. Do you want to switch to mode 2 where washing is completed more quickly? Otherwise, do you want to request drying laundry from Family A?”. According to an embodiment, the device 1700 may provide information related to the option 1780 to the user through a visual output (e.g., display indication) and/or audio output (e.g., voice output) based on an output device (e.g., a display and/or a speaker) provided therein.

According to an embodiment, the user may perform an input of selecting any one option based on the option 1780 output by the device 1700. For example, the user may select any one option through a voice input 1790 (e.g., “Yes, switch to mode 2”). According to an embodiment, an input of selecting an option may include a manual input (e.g., knob input, button input, or touch input) as well as the voice input, and the user may select any one option through the voice input or the manual input.

According to an embodiment, the device 1700 may perform an operation related to the first schedule based on the selected option. For example, the device 1700 may switch a first mode associated with the previously generated first schedule to a second mode 1755 (e.g., mode 2) based on the input (e.g., voice input or manual input) of selecting an option, and may perform the first schedule based on the changed second mode 1755. In another example, the device 1700 may transmit, to the electronic device of another user (e.g., family A) of the calendar application, request information related to the first schedule based on the input (e.g., voice input or manual input) of selecting an option.

According to an embodiment, the device 1700 may transmit the schedule information 1735 associated with the first schedule to the external server 530. According to an embodiment, before executing the first schedule, the device 1700 may be connected to the external server 530 based on a configured (or accessible) account to thereby access the calendar application. According to an embodiment, the external server 530 may receive the schedule information 1735 associated with the first schedule from the device 1700, may identify time information of the first schedule and time information of the second information based on the schedule information 1735 of the first schedule and schedule information associated with at least one second schedule stored in the calendar application, and may compare the time information of the first schedule with the time information of the second schedule.

According to an embodiment, the external server 530 may identify whether there is a section (e.g., a section where time information conflicts with each other (or overlap information)) which at least partially overlaps each other between the first schedule and the second schedule based on the comparison result between time information of the first schedule and the second schedule. For example, the external server 530 may identify whether there is a conflict between the schedules at least based on the overlap information. According to an embodiment, the external server 530 may identify whether a conflict occurs between the schedules.

According to an embodiment, when there is the section where the time information between the first schedule and the second schedule at least partially overlaps each other (e.g., when there is a conflict), the external server 530 may identify an option 1780 of changing the operation of the device related to the first schedule, and may include and transmit conflict information notifying the conflict and the identified option 1780 (e.g., ACK response) to the device 1700. According to an embodiment, when there is no section where the time information between the first schedule and the second schedule at least partially overlaps each other (e.g., when there is no conflict), the external server 530 may transmit non-conflict information (e.g., NACK response) to the device 1700. According to an embodiment, the device 1700 may output the above-described changed option 1780 based on the response (e.g., ACK response or NACK response) from the external server 530, or may perform an operation related to the previously generated first schedule.

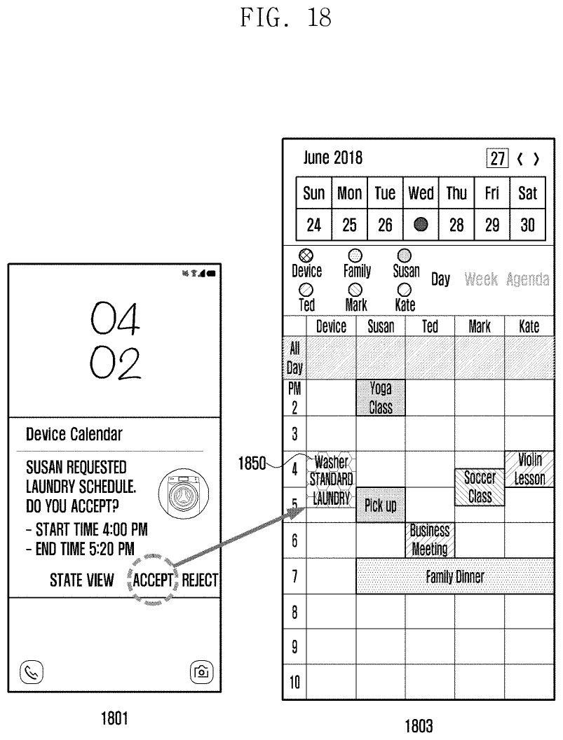

FIG. 18 is a diagram illustrating an example in which a user interface according to various embodiments is provided.

According to an embodiment, FIG. 18 illustrates an example of a case in which a user selects the third option 1760 in the example of FIG. 17A.

Referring to FIG. 18, the electronic device 101 may transmit request information related to the device schedule to a target electronic device (e.g., the electronic device of the second user (“Ted”)) based on a user input of selecting the third option 1760 of the user. According to an embodiment, the target electronic device may receive a request related to the device schedule from the electronic device 101, and may display the received request information on a display (e.g., the display device 160 in FIG. 1) as shown in an example of a screen 1801. According to an embodiment, as to the request information, as shown in the example of the screen 1801, the device schedule (e.g., washing schedule) may be requested from the first user (“Susan”), and schedule information (e.g., start time and end time) according to the device schedule and state information (e.g., state view, acceptance, and rejection) related to the device schedule may be provided.

According to an embodiment, the target electronic device may provide state view related to the device schedule, or accept or reject the device schedule based on the user input of the second user (“Ted”). According to an embodiment, the target electronic device may transmit a response related to acceptance or rejection to the electronic device 101 (e.g., the external server 530 according to an embodiment) based on the user input. According to an embodiment, FIG. 18 illustrates an example in which the second user (“Ted”) accepts the device schedule.

According to an embodiment, the electronic device 101 (or the external server 530 according to an embodiment) may apply (or reflect) the device schedule to the calendar application based on the schedule information (e.g., standard washing mode) input (or configured) by the first user (e.g., “Susan”) without changing the device schedule (e.g., without changing the operation mode of the device according to a recommended option {e.g., standard washing mode->quick mode}), based on the acceptance related to the request of the device schedule of the target electronic device (or the second user (“Ted”)).

According to an embodiment, as shown in an example of a screen 1803, the electronic device 101 may generate the device schedule in a region (e.g., a region 1850) corresponding to the configured device schedule among device schedule regions in the calendar application. For example, the electronic device 101 may maintain a configuration value in the standard washing mode and may reflect the same on the device schedule to display the same. According to an embodiment, when generating and displaying the device schedule, the electronic device 101 may classify and display device operation-related users (or a person in charge (e.g., the second user “Ted”)) based on colors.

According to an embodiment, as in the region 1770 related to the device schedule in FIG. 17A, the device schedule may be generated as “PM 4:00 to PM 4:30” (e.g., time according to the changed option) and may be provided by a corresponding color indicating that the device operation-related user is the first user (“Susan”). According to an embodiment, as in the region 1850 related to the device schedule in FIG. 18, the device schedule may be generated as “PM 4:00 to PM 5:20” (e.g., time related to the device schedule input by the first user (“Susan”)) and may be provided by a corresponding color indicating that the device operation-related user is the second user (“Ted”).

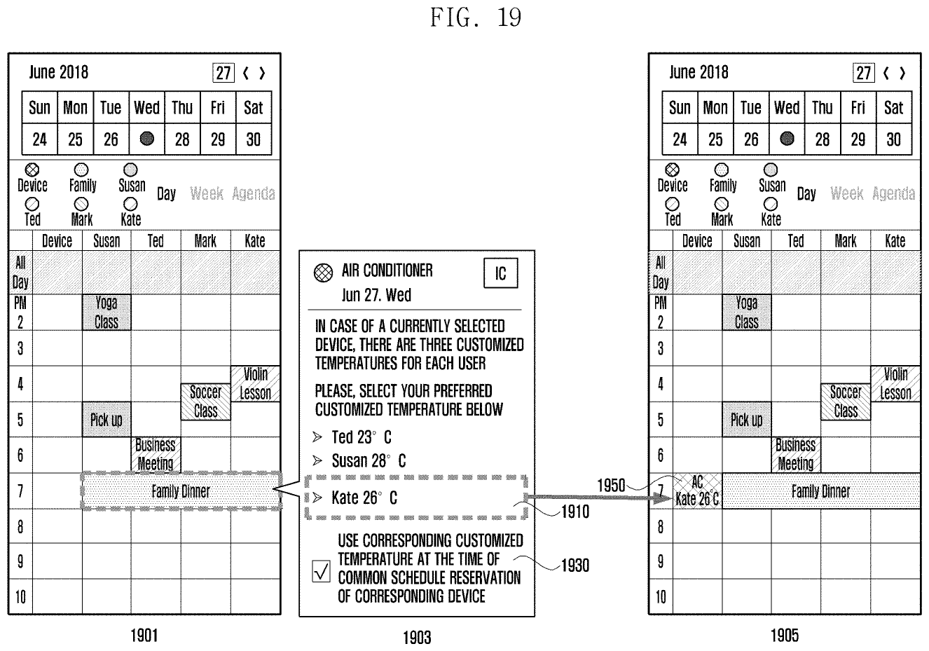

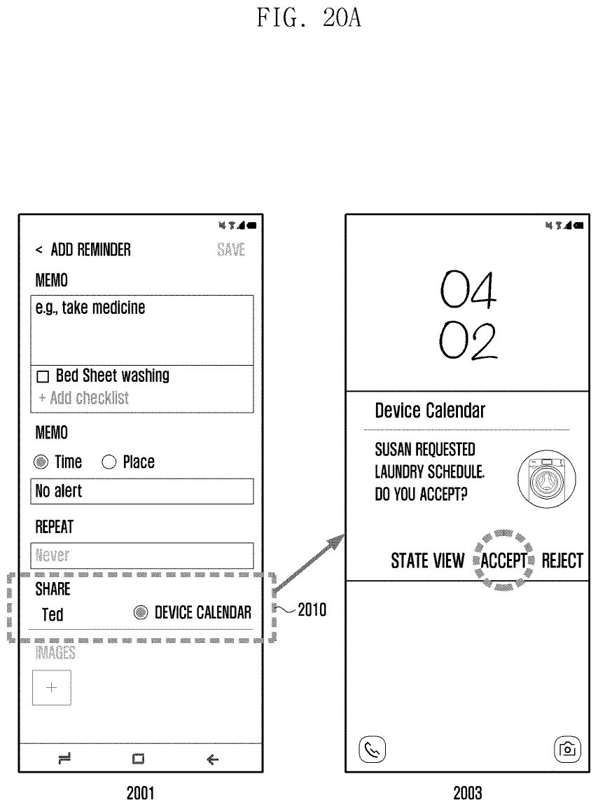

FIG. 19 is a diagram illustrating an example in which a user interface according to various embodiments is provided.

According to an embodiment, FIG. 19 illustrates another example of recommending a detailed function and a device operation of a device based on a multi-user schedule.

As shown in FIG. 19, in an example of a screen 1901, multiple users (e.g., the first user (“Susan”), the second user (“Ted”), the third user (“Mark”), and the fourth user (“Kate”)) may generate a reservation schedule for an air conditioner in a common schedule region (e.g., “Family dinner”) to receive a recommendation based on a family common schedule. For example, at least one user among the multiple users may select the common schedule region and may input schedule information related to the air conditioner. According to an embodiment, when receiving an input related to the schedule information, the electronic device 101 may analyze the input schedule information, may identify information of the user related to the common schedule, and may request the user to select a detailed function configuration value. For example, the electronic device 101 may acquire schedule information (or usage pattern) (e.g., user-specific air conditioner temperature) related to a corresponding device (e.g., air conditioner) for each of the multiple users based on the common schedule region, and may request for a selection of an appropriate configuration value by providing a configuration value related to the device for each of the multiple users.

According to an embodiment, as shown in an example of a screen 1903, the electronic device 101 may provide information on a different configuration value for each of the multiple users in association with the corresponding device (e.g., air conditioner), and may provide information for requesting a selection regarding the provided information. For example, the electronic device 101 may provide information on the presence of the different configuration value for each user related to the corresponding device (e.g., in case of a currently selected device, there are three customized temperatures for each user), information on the configuration value for each user (e.g., Ted 23 degrees, Susan 28 degrees, and Kate 26 degrees), and information requesting to select any one configuration value (e.g., please, select your preferred customized temperature below).

According to an embodiment, the electronic device 101 may further provide an additional option 1930 capable of configuring whether to preferentially apply the selected configuration value at the time of a common schedule reservation of the corresponding device (e.g., air conditioner). For example, when it is assumed that a device for which a schedule is requested in relation to the common schedule is an air conditioner, the electronic device 101 may provide the option 1930 for confirming whether to preferentially use the corresponding customized temperature selected when the air conditioner is reserved to the common schedule, and may automatically configure and provide the configuration value of the corresponding device (e.g., air conditioner) as a designated configuration value in the related common schedule thereafter at the time of a user selection regarding the option.

According to an embodiment, the electronic device 101 may apply the device schedule (e.g., register the schedule of the operation mode of the device according to the configuration value) in association with the common schedule based on a user input of selecting any one configuration value 1910 (e.g., Kate 26 degrees), and may apply (or reflect) the device schedule to the calendar application.

According to an embodiment, as shown in an example of a screen 1905, the electronic device 101 may generate a corresponding schedule in a region (e.g., a region 1950) corresponding to the common schedule related to the multiple users among the device schedule regions in the calendar application. For example, the electronic device 101 may register an air conditioner schedule and may reflect and display a change to a designated configuration value (e.g., Kate 27 degrees) in the operation mode (e.g., operation temperature) of the air conditioner. According to an embodiment, when generating and displaying the device schedule, the electronic device 101 may classify and display device operation-related users (or a person in charge (e.g., “Kate”)) based on colors.

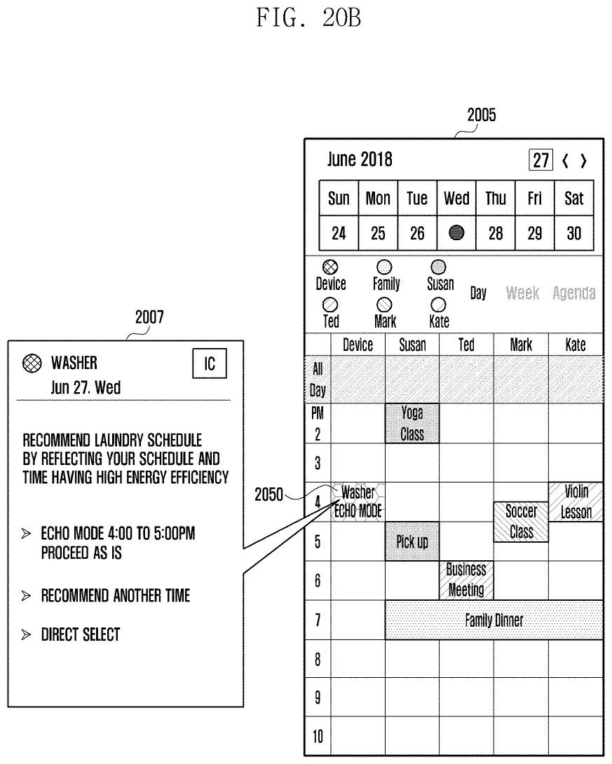

FIG. 20A is a diagram illustrating another example of adding a device schedule according to various embodiments, and FIG. 20B is a diagram illustrating an example in which a user interface is provided according to various embodiments.

According to an embodiment, FIGS. 20A and 20B illustrate an example of adding a device control schedule to the calendar application through another associated application (e.g., reminder application) other than a direct input based on the calendar application.

Referring to FIG. 20A, an example of a screen 2001 shows a user interface of another (or associated) application (e.g., reminder application) capable of adding a device control schedule. According to an embodiment, the electronic device 101 may receive a user input for executing the reminder application and may execute the reminder application based on the user input.

According to an embodiment, in the example of a screen 2001, the electronic device 101 may display a user interface related to the reminder application on a display (e.g., the display device 160 in FIG. 1). A user may generate a to-do list based on the user interface as in the example of the screen 2001. For example, the user may configure (or activate) a corresponding function to assign the device schedule to another user (e.g., “Ted”). For example, in the example of the screen 2001, a configuration of “device calendar” may be turned on as shown in an example of an element 2010.

According to an embodiment, based on a user input for configuring “device calendar” of the user, the electronic device 101 may transmit request information related to the device schedule to a target electronic device (e.g., the electronic device of “Ted”). According to an embodiment, the target electronic device may receive a request related to the device schedule from the electronic device 101, and may display the received request information on a display as shown in an example of a screen 2003. According to an embodiment, as shown in the example of the screen 2003, as to the request information, the device schedule (e.g., washing schedule) may be requested from the user (e.g., “Susan”) of the electronic device 101, and state information (e.g., state view, acceptance, and rejection) related to the device schedule may be provided.

According to an embodiment, the target electronic device may provide a state view related to the device schedule, or accept or reject the device schedule based on the user input of the user (e.g., “Ted”). According to an embodiment, the target electronic device may transmit a response related to acceptance or rejection to the electronic device 101 (or the external server 530 according to an embodiment) based on the user input. According to an embodiment, FIG. 20 illustrates an example in which the user (e.g., “Ted”) accepts the device schedule.

According to an embodiment, the electronic device 101 (or the external server 530 according to an embodiment or the electronic device of the user (“Ted”)) may register the device schedule in the calendar application based on the acceptance related to the request of the device schedule. According to an embodiment, when the device schedule is registered, it is possible to register the device schedule as the schedule of a target user (e.g., “Ted”) related to the device schedule in consideration of the entire schedule of the target user (e.g., “Ted”) and/or a specific condition (e.g., an option optimized for the device operation {e.g., a low-electric charge section (or time zone)}). An example of this is shown in FIG. 20B.

According to an embodiment, as shown in an example of a screen 2005, the device schedule may be generated in a region (e.g., a region 2050) corresponding to the configured device schedule among the device schedule regions in the calendar application. For example, the electronic device 101 may reflect and represent an echo mode to the device schedule. According to an embodiment, when generating the device schedule, the electronic device 101 may identify the entire schedule of the target user (e.g., “Ted”) and the optimized condition (e.g., low-electric charge section) related to the device operation to thereby suggest the identified information as an option. For example, as shown in an example of a screen 2007, information related to a recommendation (e.g., recommend washing schedule by reflecting your schedule and high energy-efficient time) and related options (e.g., a first option {e.g. air conditioner mode 4:00 to 5:00 PM}, a second option (e.g., another time recommendation), a third option (e.g., direct selection)) may be provided.

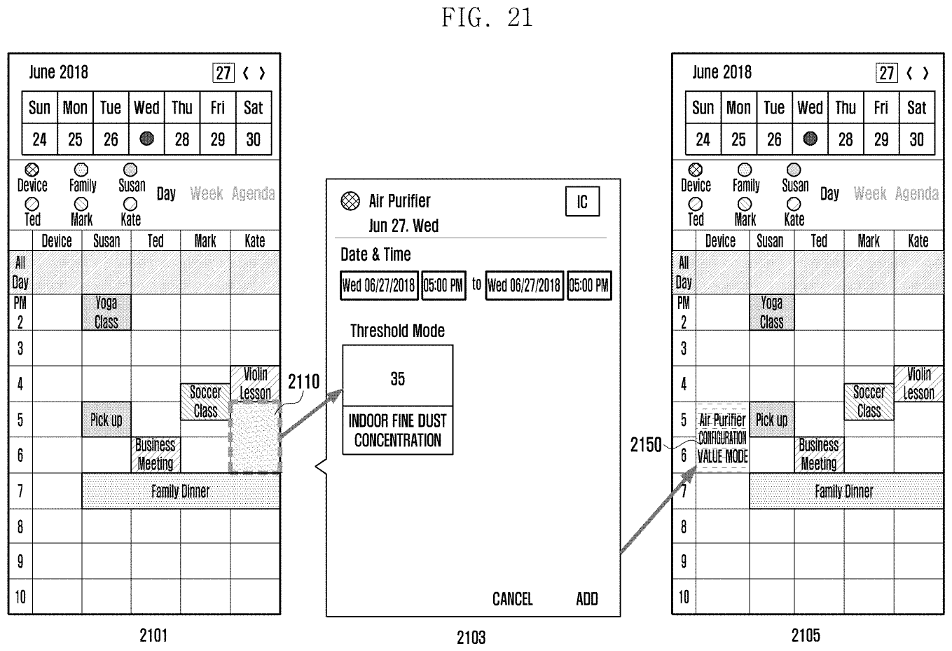

FIG. 21 is a diagram illustrating an example in which a user interface according to various embodiments is provided.

According to an embodiment, FIG. 21 illustrates an example of configuring a reservation schedule related to a device so that the device can be operated based on a configured condition (e.g., sensor-based measurement {or sensing value}).

Referring to FIG. 21, in an example of a screen 2101, a user (e.g., “Kate”) may generate a reservation schedule related to an air purifier in an input region (e.g., a region 2110) for a new schedule among the schedule regions of the user to receive a recommendation related to the device based on the schedule of the user.

According to an embodiment, as shown in an example of a screen 2103, the user may configure a time section for the device schedule related to the device (e.g., air purifier), and may configure a condition (or threshold mode) for the operation of the device. For example, the user may configure the time section and condition so that the device can be operated when a measurement value obtained by a sensor mounted in the device exceeds a specific numerical value (e.g., indoor fine dust concentration 35).

According to an embodiment, in an example of a screen 2105, when the measurement value obtained by the sensor mounted in the device reaches a specific configuration value, the electronic device 101 may generate and display a device schedule (e.g., “air purifier, configuration value mode”) for causing the device to be operated in a corresponding region (e.g., a region 2150) among the device schedule regions, based on a user input for registering the schedule related to the device. According to an embodiment, when generating and displaying the device schedule, the electronic device 101 may classify and display device operation-related users (or a person in charge (e.g., “Kate”)) based on colors.

According to an embodiment, the user may input the device schedule related to the device in the user schedule region of the user or the device schedule region. As shown in an example of a screen 2101, when the user configures the device schedule through the user schedule, the electronic device 101 may identify the device schedule in the schedule information input according to the user input, and may display the identified device schedule in the device schedule region as shown in the example of the screen 2105. According to an embodiment, when the user schedule is included in the schedule information according to the user input, in the example of the screen 2105, the electronic device 101 may display corresponding schedule information in a corresponding region (e.g., a region selected in the example of the screen 2101) among the user schedule regions of the user.

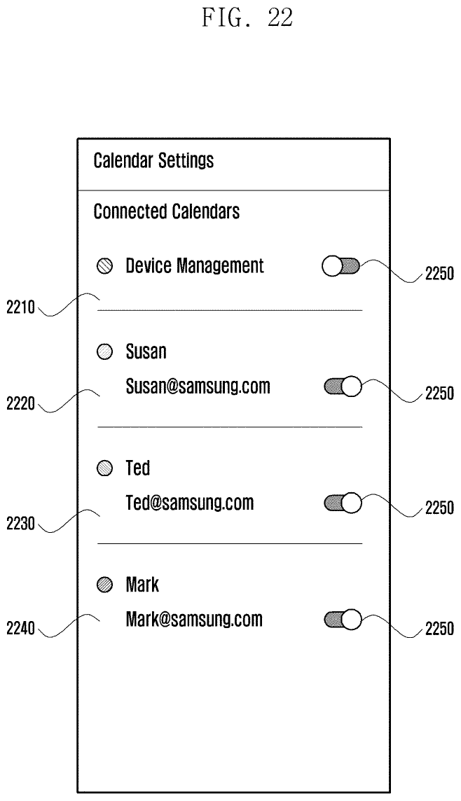

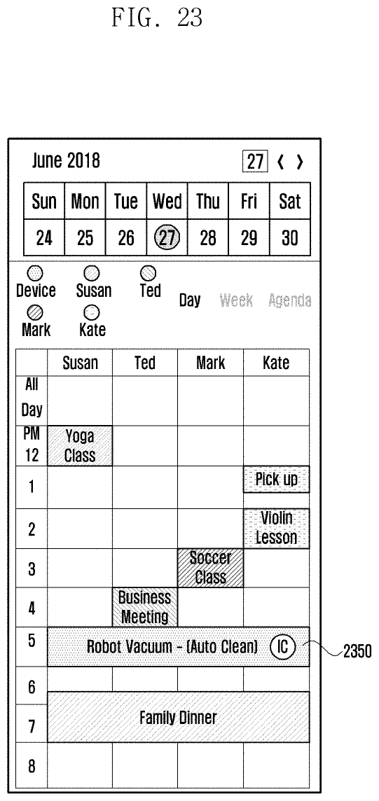

FIG. 22 is a diagram illustrating an example of an interface configuration related to a user interface according to various embodiments, and FIG. 23 is a diagram illustrating another example of a user interface according to various embodiments.

Referring to FIG. 22, an example of an interface (e.g., calendar settings) for a configuration related to the calendar application is illustrated. As illustrated in FIG. 22, a user may select and configure a target item to be schedule-managed through the calendar application in a configuration menu of the calendar application. According to an embodiment, it is possible to configure ON/OFF (e.g., activation/deactivation) related to a target (e.g., device or multiple users) to be schedule-managed through calendar application through the configuration menu.

For example, the user may configure ON/OFF (e.g. whether to display ON/OFF through the calendar application) related to a device schedule 2210 and user schedules 2220, 2230, and 2240 for each of the multiple users using an ON/OFF toggle button 2250. For example, the user may configure a type (e.g., calendar type) of the user interface of the calendar application based on the toggle button 2250. For example, based on ‘ON’ of the toggle button 2250 associated with the device schedule 2210, it is possible to provide the user interface as the calendar type for the device schedule.

According to an embodiment, in the user interface related to the calendar application, it is possible to selectively provide a region related to the device schedule. For example, in FIG. 22, when the user configures the toggle button 2250 as OFF in a device management tap, it is possible to provide a schedule region related to the multiple users except the device schedule region in the user interface related to the calendar application as shown in the example of FIG. 23.

According to an embodiment, as shown in the example of FIG. 23, when the device schedule region is excluded, the electronic device 101 may display the state and usage schedule of the device as one schedule (or event) in the user interface in relation to the device schedule by at least one user, thereby registering and managing the corresponding information as one schedule (e.g., common schedule 2350 {e.g., robot vacuum—(auto clean)}) related to the multiple users.

According to an embodiment, a schedule box related to the common schedule 2350 may be freely moved to regions of other time zones based on a user input (e.g., drag & drop) of at least one user, and the electronic device 101 may change and manage the operation (e.g., operation time) schedule of the device based on the moved schedule region.

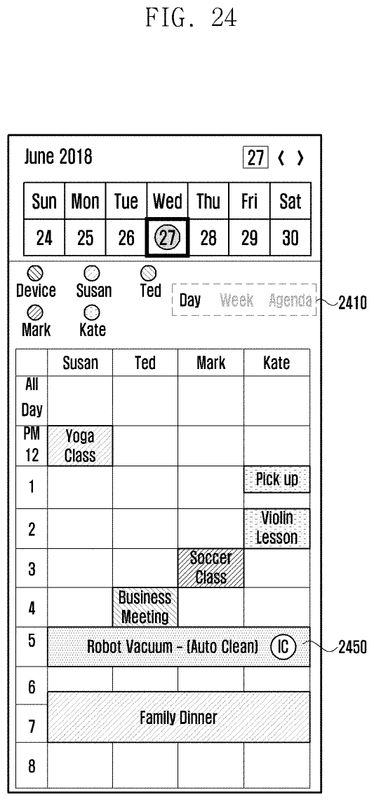

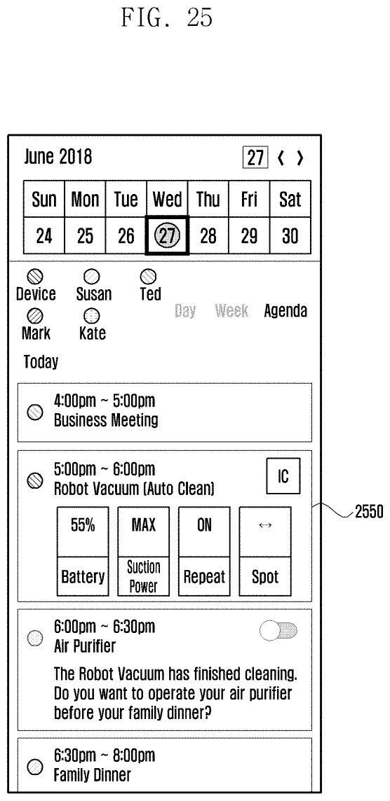

FIG. 24 is a diagram illustrating an example in which a user interface is provided according to various embodiments, and FIG. 25 is a diagram illustrating an example in which a user interface is provided according to various embodiments.

According to an embodiment, FIGS. 24 and 25 illustrate an example of providing schedule information according to a viewing method selection of a user in an example of a user interface as illustrated in FIG. 23.

Referring to FIG. 24, in an example of a screen of FIG. 24, an element 2410 may indicate an object (e.g., a first object (“day”), a second object (“week”), and a third object (“agenda”)) capable of selecting a viewing method (e.g., dashboard view) of a user interface included in the calendar application. For example, the user may select the object 2410 related to the viewing method and may change the viewing method related to the schedule information of the user interface. According to an embodiment, FIG. 24 illustrates an example of providing schedule information related to multiple users and the device in a daily view based on the selection of the object “day” among the objects 2410 related to the viewing method. According to an embodiment, the user may change the schedule information related to the multiple users and the device to a weekly view based on the selection of the object “week” among the objects 2410 related to the viewing method, or may change the same to detailed schedule information view related to the multiple users and the device based on the selection of the object “agenda”.

According to an embodiment, in the example of FIG. 24, as to the device schedule 2450, according to the selection of the viewing method, the functional categories that can control the device schedule 2450 (e.g., “robot vacuum-(auto clean)) may be changed. For example, when the object “agenda” is selected in the state as illustrated in the example of FIG. 24, the electronic device 101 may provide the user interface as illustrated in FIG. 25 to the user.

Referring to FIG. 25, as shown in the example of FIG. 25, a user interface including detailed schedule information related to the multiple users and the device may be provided. According to an embodiment, as the detailed information, detailed schedule information of the user schedule related to the multiple users and detailed schedule information of the device schedule related to the multiple users or the common device schedule may be provided.

According to an embodiment, in the example of FIG. 25, detailed schedule information 2550 (e.g., functional category) related to the device schedule 2450 of FIG. 24 may be provided. According to an embodiment, the detailed schedule information related to the device schedule 2450 may include, for example, specific information (e.g., operation time information) related to the device schedule and information on the functional category capable of controlling the device (e.g., mode configuration value). According to an embodiment, the electronic device 101 may select the detailed schedule information 2550 related to the device schedule 2450 to change and configure the functional category related to the control of the device according to the user input. For example, the user may switch the corresponding mode to an edition mode related to the control of the device by selecting (e.g., touching) the detailed schedule information 2550, and may configure a mode (or a configuration value) related to the device-related control in the edition mode to thereby change the device schedule.

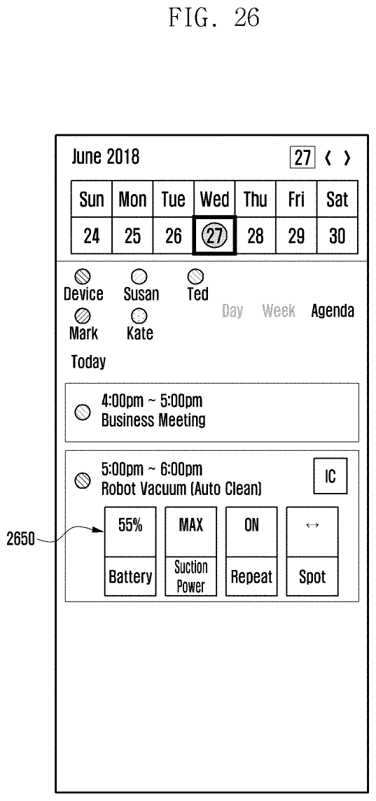

FIG. 26 is a diagram illustrating an example of recommending a configuration regarding a device schedule based on a user interface according to various embodiments.

Referring to FIG. 26, when generating a device schedule based on a user input, the electronic device 101 may recommend and provide a function of a device mainly used by a user as a basic configuration value 2650.

According to an embodiment, the electronic device 101 may analyze schedule information according to the user input and may identify a device related to a device schedule based on the schedule information. According to an embodiment, the electronic device 101 may analyze a usage pattern of the user associated with the identified device, and may recommend and provide the configuration value of the function mainly used by the user with respect to the corresponding device based on the usage pattern as the basic configuration value 2650.

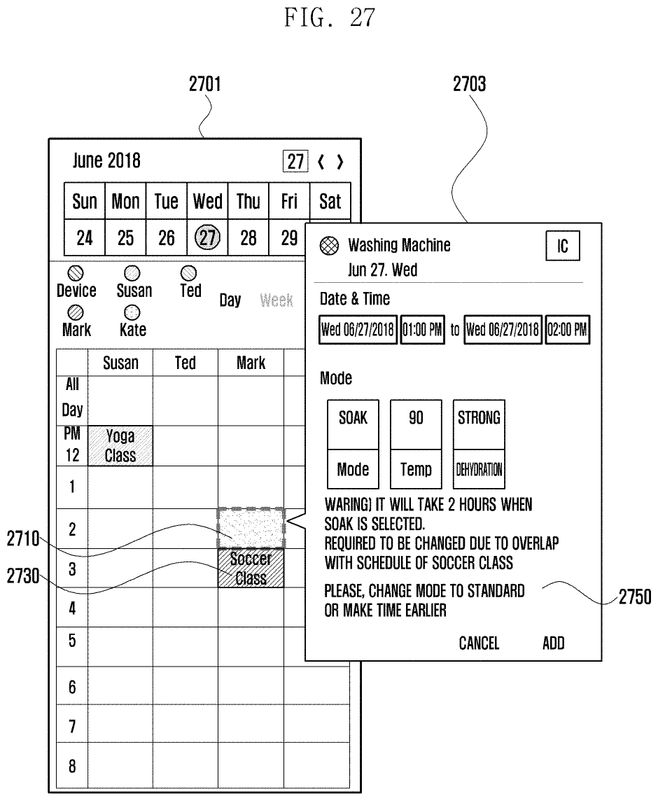

FIG. 27 is a diagram illustrating an example of recommending a configuration regarding a device schedule based on a user interface according to various embodiments.

Referring to FIG. 27, the electronic device 101 may generate or change a device schedule based on a user input. According to an embodiment, when generating or changing the device schedule, the electronic device 101 may suggest a configuration option related to the device based on a state of the device and/or a user schedule of the user.

According to an embodiment, in the example of screen 2701, the user may input a device schedule related to the device based on a region 2710 related to the device schedule. According to an embodiment, as shown in an example of a screen 2703, the user may configure (or change) an operation mode (e.g. mode-soak, temperature-90 degrees, and dehydration-strong) related to the operation of the washing machine. According to an embodiment, when the device schedule is generated or changed, the electronic device 101 may analyze the state of the device and the user schedule of the user. For example, the electronic device 101 may identify whether there is a conflict between the device schedule input through the region 2710 and an adjacent schedule (e.g., an adjacent user schedule) (e.g., a user schedule {e.g., soccer class} of the region 2730).

According to an embodiment, when the device schedule and the adjacent schedule conflicts with each other, the electronic device 101 may identify an option within a function range capable of avoiding the conflict, and may provide the user with information related to the conflict and information related to the identified option. According to an embodiment, in the example of the screen 2703, the electronic device 101 may provide, as illustrated in the element 2750, the information related to the conflict (e.g., “warning: it will take 2 hours when soak is selected. Required to be changed due to overlap with schedule of soccer class”) and the information related to the change option (e.g., “please change mode to standard or make time earlier”). For example, the electronic device 101 may recommend an option (e.g., configuration value) (e.g., element 2750) related to the device based on the state of the device and/or the user schedule of the user.

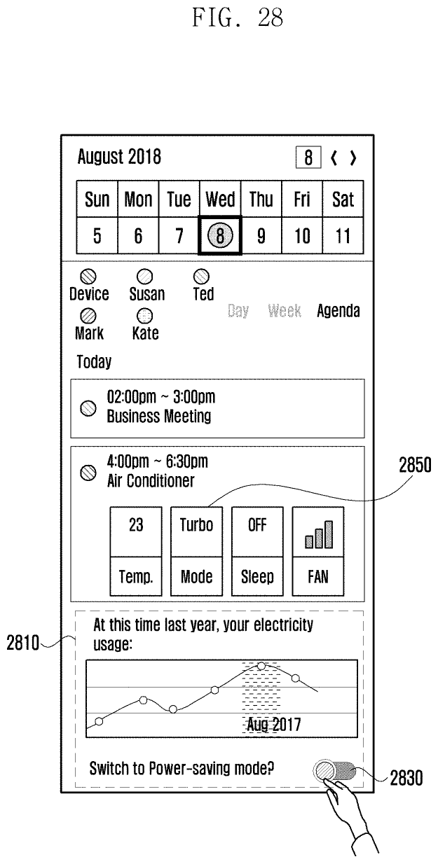

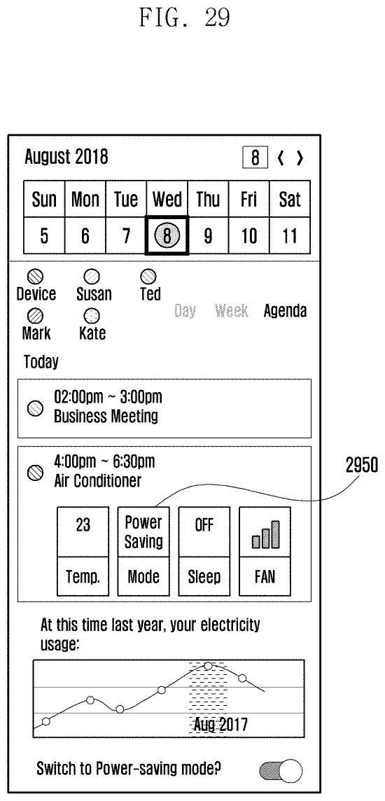

FIG. 28 is a diagram illustrating an example of recommending a configuration regarding a device schedule based on a user interface according to various embodiments, and FIG. 29 is a diagram illustrating an example of recommending a configuration regarding a device schedule based on a user interface according to various embodiments.

Referring to FIGS. 28 and 29, the electronic device 101 may generate or change a device schedule based on a user input. According to an embodiment, when generating or changing the device schedule, the electronic device 101 may provide associated information associated with the device and a recommendation related to a change in a predetermined configuration value based on the associated information.

According to an embodiment, in the screen example of FIG. 28, a user may generate a device schedule associated with a device (e.g., an air conditioner). According to an embodiment, when the device schedule associated with the device is generated, the electronic device 101 may provide associated information 2810 of another application (or another service) (e.g., a 3rd party service) associated with the device. According to an embodiment, when generating the device schedule, the electronic device 101 may identify another service (e.g., a device usage pattern providing service) of interest to the user in relation to the use of the corresponding device based on the user's usage pattern. According to an embodiment, the electronic device 101 may analyze the associated information 2810 of the other service and may recommend a change in the predetermined value to the device based on the associated information 2810.

According to an embodiment, the electronic device 101 may provide an object 2830 that can change a configuration related to the device based on the other service. According to an embodiment, the object 2830 may include an object (e.g., ON/OFF button) capable of selecting ON/OFF (or activation/deactivation) for an added option (e.g., power-saving mode switching) based on the associated information 2810.

According to an embodiment, the electronic device 101 may change the predetermined configuration value related to the device based on a user input (e.g., apply recommended option)(e.g., ON configuration based on the object 2830) related to the object 2830, and may provide the changed configuration value to the user. An example of this is shown in FIG. 29. In the example of the screen of FIG. 29, the electronic device 101 may change and provide the previous configuration value 2850 (e.g., mode:turbo) related to the device to a configuration value 2950 (e.g., mode:power saving) according to the recommended option. For example, the electronic device 101 may change “turbo mode 2850” among the previous configuration values of the device (e.g., air conditioner) to “power saving mode 2950” based on the user input (e.g., object 2830 activation) to which the recommended configuration value is applied based on the associated information 2810, and may provide the changed information to the user.

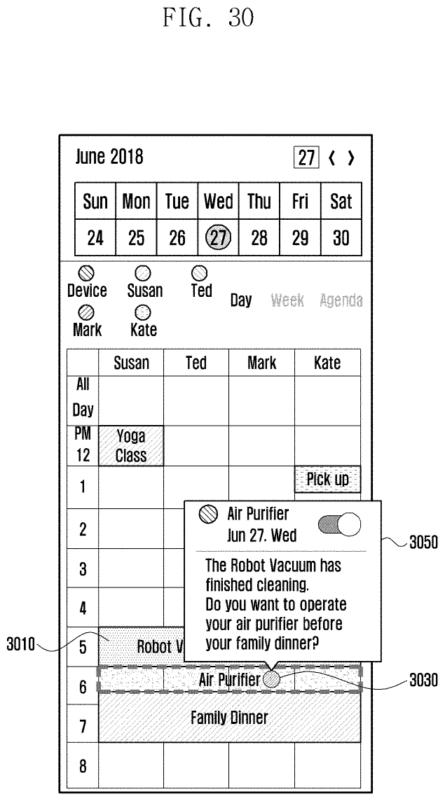

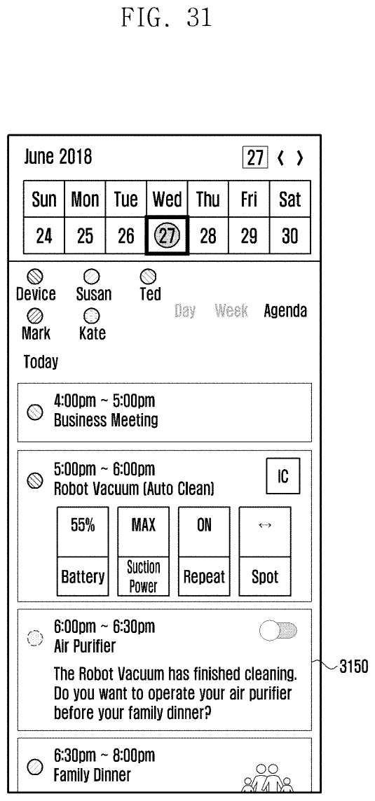

FIG. 30 is a diagram illustrating an example of recommending a configuration regarding a device schedule based on a user interface according to various embodiments, and FIG. 31 is a diagram illustrating an example of recommending a configuration regarding a device schedule based on a user interface according to various embodiments.

Referring to FIGS. 30 and 31, the electronic device 101 may analyze a usage pattern of another device (e.g., a second device) used in series with a device (e.g., a first device), and may provide a schedule reservation and/or recommendation related to the other device (e.g., the second device or the first device) used in series with the corresponding device (e.g., the first device or the second device) when the device schedule related to any one of the first device and the second device is generated or changed.

According to an embodiment, in the screen example of FIG. 30, the electronic device 101 may generate a device schedule 3010 related to the first device (e.g., robot vacuum) based on a user input. According to an embodiment, when generating the device schedule 3010 related to the first device, the electronic device 101 may identify the second device used in series with the first device based on the calendar application, and may analyze the usage pattern of the second device.

According to an embodiment, the electronic device 101 may generate a device schedule 3030 related to the second device based on the usage pattern of the second device, and may recommend (or provide) the generated schedule to the user. According to an embodiment, the electronic device 101 may identify the history (e.g., schedule of another device registered (or used) in association with the schedule of the first device) of at least one other devices used in series in association with (or in linkage with) the first device based on the calendar application, and may identify at least one other devices that can be continuously operated in association with (in linkage with) the first device based on the identified history.

According to an embodiment, the electronic device 101 may superimpose (or pop up) detailed information 3050 related to the device schedule 3030 of the second device on a user interface based on a user input related to the device schedule 3030 of the second device and may provide the superimposed information. According to an embodiment, FIG. 31 may show an example of switching to a detailed page related to a user schedule and a device schedule according to a user's viewing method selection. In the screen example of FIG. 31, the electronic device 101 may add (e.g., reserve/recommend) detailed information 3150 related to the device schedule related to the second device used in series with the first device to the device schedule related to the first device generated based on the user input, and may provide the added information to the user.

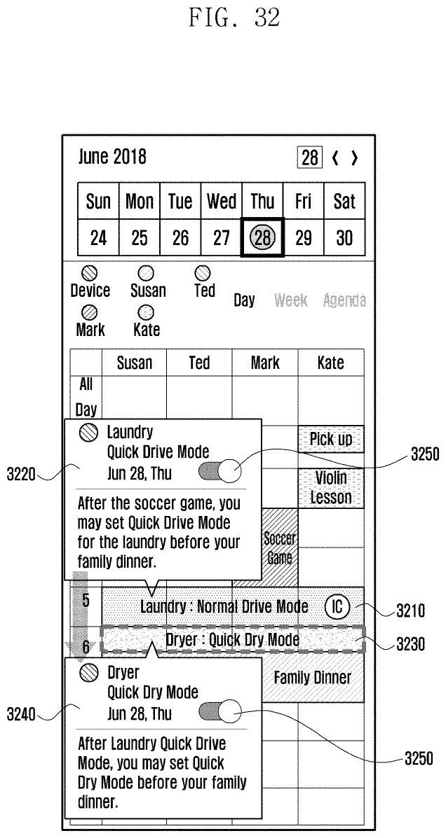

FIG. 32 is a diagram illustrating an example of recommending a configuration regarding a device schedule based on a user interface according to various embodiments.

Referring to FIG. 32, the electronic device 101 may recommend a configuration related to a device schedule based on a multi-user schedule. According to an embodiment, the electronic device 101 may recommend the configuration related to the device schedule based on the multi-user schedule related to the multiple users and a complex element of multiple devices. For example, the electronic device 101 may recommend a configuration related to a device schedule previously configured in the second device in consideration of the device schedule previously configured in the first device and/or the operation of the first device.

According to an embodiment, in the example screen of FIG. 32, a first device schedule 3210 (e.g., laundry: normal drive mode) associated with a first device (e.g., a washing machine) and a second device schedule 3230 (e.g., dryer: quick dry mode) associated with a second device (e.g., a dryer) may be in a configured state. According to an embodiment, the electronic device 101 may recommend an option change of a device schedule related to at least one device, in consideration of a user schedule (e.g., soccer game or family dinner) and/or previously configured device schedules related to the first device and the second device.

According to an embodiment, in the screen example of FIG. 32, the electronic device 101 may analyze the user schedule (e.g., family dinner), a first device schedule 3210, and a second device schedule 3230 to thereby determine whether a conflict occurs between the user schedule (e.g., family dinner) and the device schedule when the first device and the second device are operated based on the first device schedule 3210 and the second device schedule 3230.

According to an embodiment, when the conflict occurs between the schedules, the electronic device 101 may recommend an option change related to at least one device in consideration of the operation state of the first device and the second device. According to an embodiment, the electronic device 101 may suggest an option for completing the device schedule associated with the first device and the second device before the user schedule (e.g., family dinner).

For example, in the screen example of FIG. 32, the electronic device 101 may superimpose (or pop up), on the user interface, a recommended option (e.g., quick dry mode) related to the recommended option 3220 (e.g., quick drive mode) of the first device (e.g., laundry) and the recommended option 3240 (e.g., dryer) of the second device based on the user input, and may provide the superimposed information. According to an embodiment, the recommended options 3220 and 3240 may include an object 3250 (e.g., ON/OFF object) for stopping (or canceling) the operation of the device (or the device schedule).

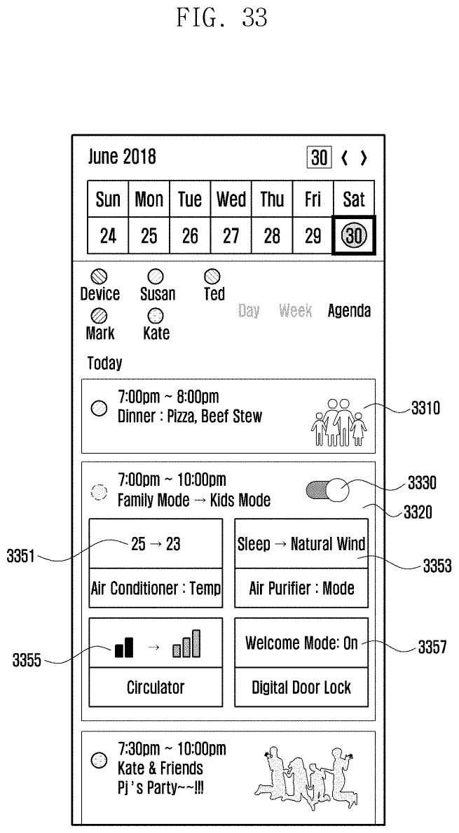

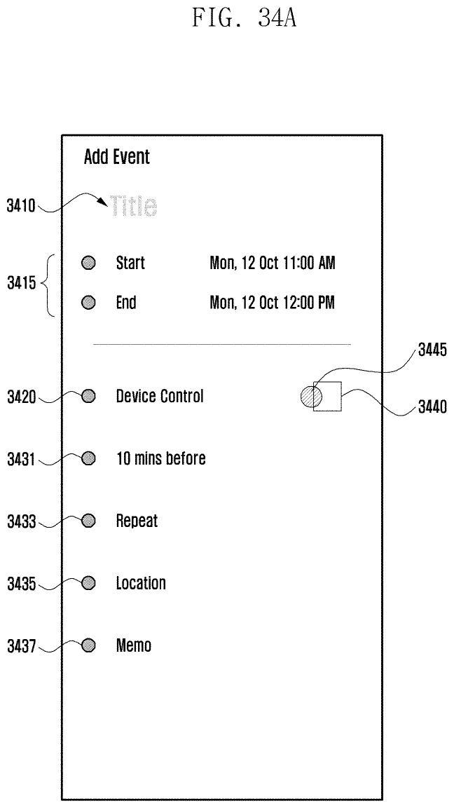

FIG. 33 is a diagram illustrating an example of recommending a configuration regarding a device schedule based on a user interface according to various embodiments.

Referring to FIG. 33, the electronic device 101 may recommend a configuration related to a device schedule based on a multi-user schedule. According to an embodiment, the electronic device 101 may recommend the configuration related to the device schedule based on a multi-device schedule associated with multiple users and a complex element of multiple devices. For example, the electronic device 101 may recommend a configuration related to a device by reflecting a priority to a common device schedule among multiple users.

According to an embodiment, in the example screen of FIG. 33, the electronic device 101 may configure the functions of the multiple devices using a basic (or common) configuration value (e.g., operating in family mode of multiple devices) related to multiple devices (e.g., air conditioner, air purifier, circulator, digital door lock, etc.) in a common schedule 3310 among the multiple users.

According to an embodiment, the electronic device 101 may identify information of a user related to the common schedule 3310, and may identify the basic configuration value (e.g., operating in kids mode of the multiple devices) of the multiple devices related to the user having the priority. According to an embodiment, when the basic configuration value related to the device is different from the basic configuration value related to the device of the user having the priority among the multiple users, the electronic device 101 may recommend and provide the basic configuration value related to the device as the basic configuration value related to the device of the user having the priority.

According to an embodiment, as shown in the screen example of FIG. 33, when the basic configuration value of the multiple devices related to the multiple users is “family mode” and the basic configuration value of the multiple devices related to the user having the priority is “kids mode”, the electronic device 101 may provide recommendation information 3320 for recommending a change to “kids mode” in the configuration of the device by reflecting the priority of the user having the priority. According to an embodiment, in the user interface, the electronic device 101 may provide, to the user for each device, information 3351, 3353, 3355, and 3357 on a configuration change between the basic configuration value according to “family mode” based on the common schedule and the basic configuration value according to “kids mode” based on the user having the priority.

According to an embodiment, in the screen example of FIG. 33, the electronic device 101 may provide an object 3330 (e.g., a function ON/OFF button) that allows a user to select whether to apply a recommendation in relation to the configuration value of the device schedule, and the user may select whether to apply the basic configuration value recommended based on the object 3330.

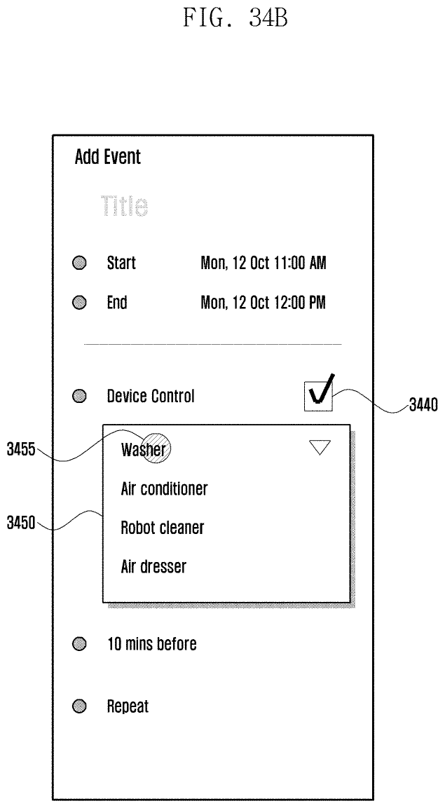

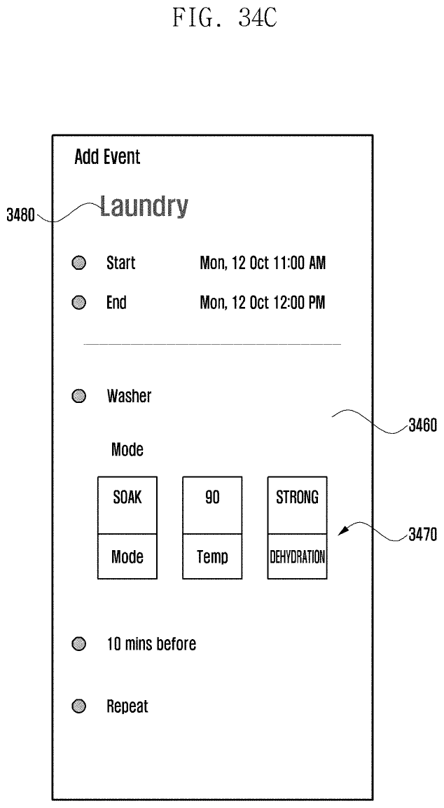

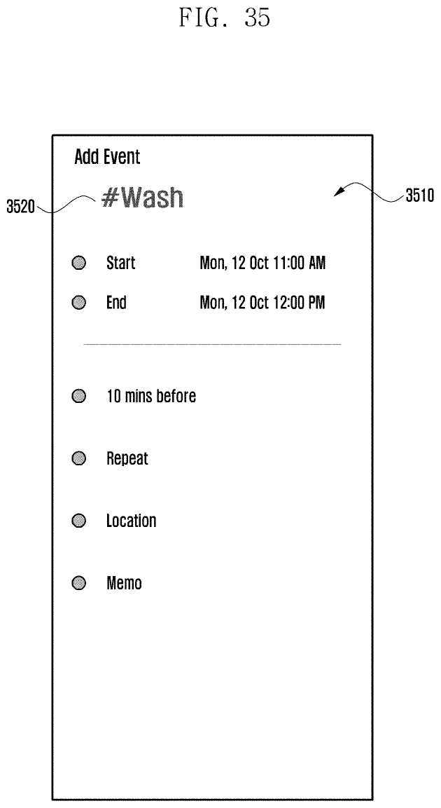

FIG. 34A is a diagram illustrating an example in which a user interface is provided according to various embodiments, FIG. 34B is a diagram illustrating an example in which a user interface is provided according to various embodiments, and FIG. 34C is a diagram illustrating an example in which a user interface is provided according to various embodiments.

According to an embodiment, FIGS. 34A, 34B, and 34C are diagrams illustrating an example of generating a device schedule based on a configuration menu (or configuration interface) for generating the device schedule.

As shown in FIG. 34A, a user interface (or a configuration menu) of a calendar application according to various embodiments may include a title region 3410 on which a title (or device name or schedule name) associated with a device schedule is displayed, a time configuration region 3415 for configuring time information related to the operation of the device (e.g., start time and completion time), a schedule object 3440 for selecting whether to apply the device schedule, a device control menu 3420 for device selection, a notification time menu 3431 (e.g., 10 mins before) for notification feedback time configuration related to the device schedule, a repeat menu 3433 (e.g., repeat) for schedule repeat configuration, a menu 3435 (e.g., location) for location configuration, and/or a menu 3437 (e.g., memo) for inputting additional information.

According to an embodiment, the user may select (e.g., touch 3445) the schedule object 3440 to generate (or activate) the device schedule. According to an embodiment, when the user wants to apply (or activate) the device schedule, the user may select (e.g., touch) the device control menu 3420.

According to an embodiment, the electronic device 101 may receive a user input for selecting the schedule object 3440 or the device control menu 3420. According to an embodiment, the electronic device 101 may display a visual object V on the schedule object 3440 to indicate that the device schedule is activated, based on the user input, as illustrated in FIG. 34B, and may display a device list including information (e.g., device name or type) (e.g., washer, air conditioner, robot cleaner, or air dresser) related to at least one device through a submenu 3450 associated with the device control menu 3420. For example, the submenu 3450 including the device list may be displayed at the bottom of the device control menu 3420 in a frame-in manner.

According to an embodiment, the electronic device 101 may receive a user input 3455 (e.g., a touch) for selecting any one device based on the submenu 3450. For example, according to the example of FIG. 34B, the user may select an item “washer” among information items related to the device of the submenu 3450. According to an embodiment, the electronic device 101 may receive a user input for selecting a specific item (e.g., “washer” item) in the submenu 3450, and may identify the device associated with the selected item based on the user input.

According to an embodiment, as illustrated in FIG. 34C, the electronic device 101 may display information and options related to a device identified in association with the selected item through the user interface. For example, the electronic device 101 may identify the device (e.g., washer) associated with the “washer” item, may display the schedule name 3480 (e.g., laundry) related to the device in the title region 3410, and may display the option 3470 (e.g., information related to the operation mode {e.g., “mode:soak, temp: 90 degrees, dehydration: strong”}) related to the corresponding device through the option region 3460.

FIG. 35 is a diagram illustrating an example in which a user interface is provided according to various embodiments.

According to an embodiment, FIG. 35 is a diagram illustrating a configuration menu (or a configuration interface) for generating a device schedule and another example of generating a device schedule based on the configuration menu.

According to various embodiments, the electronic device 101 may generate (or recommend) a device schedule based on a keyword using hash tags (#) in the configuration menu. According to an embodiment, as shown in FIG. 35, the user may input a combination 3520 of the hash tags (e.g., hash symbol “#”) and information (or keywords (or words))(e.g., “wash”) associated with a device for which the user desires to generate a device schedule, in the title region 3510. For example, the user may input “#wash” 3520 in the title region 3510.

According to an embodiment, the electronic device 101 may recognize the hash tag (#) as a command for keyword search based on the input of the hash tags (#) and the keywords (e.g., “#wash”) 3520 (e.g., attaching hash symbol “#” to keyword (or word)), and may identify a device (e.g., “washer”) associated with the corresponding keyword (e.g., “wash”). According to an embodiment, the electronic device 101 may display information and options related to the device identified in association with the keyword through the user interface, as illustrated in FIG. 34C. For example, the electronic device 101 may identity the device (e.g., washer) associated with the keyword “wash”, may display the schedule name 3480 (e.g., laundry) related to the corresponding device in the title region 3410, and may display the option 3470 (e.g., information related to the operation mode {e.g., “mode:soak, temp: 90 degrees, dehydration: strong”}) related to the corresponding device through the option region 3460.

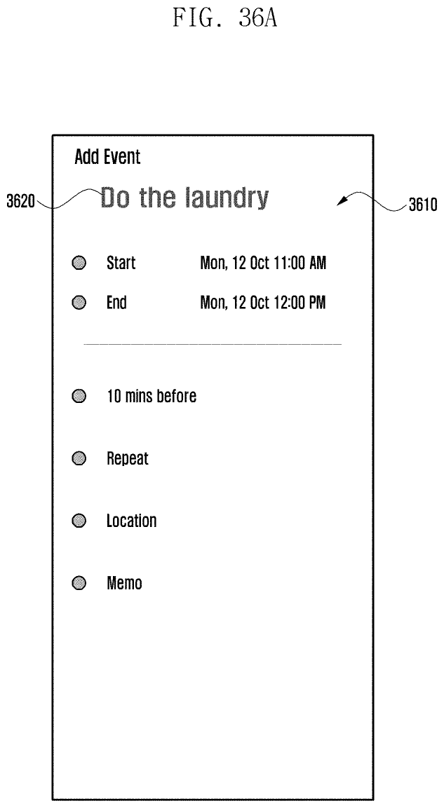

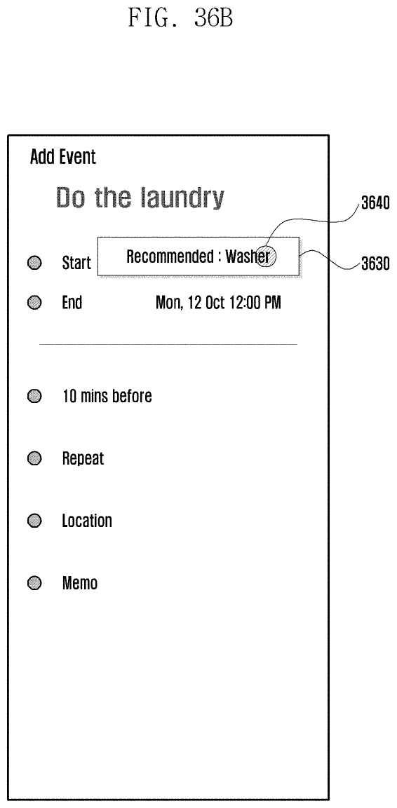

FIG. 36A is a diagram illustrating an example in which a user interface is provided according to various embodiments, and FIG. 36B is a diagram illustrating an example in which a user interface is provided according to various embodiments.

According to an embodiment, FIGS. 36A and 36B are diagrams illustrating a configuration menu (or a configuration interface) for generating a device schedule and another example of generating a device schedule based on the configuration menu.

According to various embodiments, the electronic device 101 may generate (or recommend) a device schedule based on keyword (or word) recognition in the configuration menu. According to an embodiment, as shown in FIGS. 36A and 36B, a user may input information 3620 (or keyword (or word)) (e.g., “do the laundry”) related to a device for which the user desires to generate a device schedule in the title region 3610. For example, the user may input “do the laundry” 3620 in the title region 3610.

According to an embodiment, the electronic device 101 may perform word recognition on the keyword (e.g., “do the laundry” 3620), and may identify the device (e.g., “washer”) associated with the keyword based on the word recognition. According to an embodiment, the electronic device 101 may recommend and provide information 3630 of a device associated with the keyword. According to an embodiment, the electronic device 101 may display information and options related to the device identified in association with the keyword through the user interface, as illustrated in FIG. 34C based on a user selection 3640 for the information 3630. For example, the electronic device 101 may identify the device (e.g., washer) associated with the “wash” keyword, may display the schedule name 3480 (e.g., laundry) related to the device in the title region 3410, and may display the option 3470 related to the corresponding device (e.g., information related to the operation mode {e.g., “mode:soak, temp: 90 degrees, dehydration: strong”}) through the option region 3460.

As described above, a method of operating the electronic device 101 according to various embodiments may include: acquiring schedule information associated with an operation of a device from a user; generating at least one first schedule based on the schedule information; identifying at least one second schedule stored in a calendar application; identifying a section in which time information of the first schedule and time information of the second schedule at least partially overlap each other by comparing the time information of the first schedule with the time information of the second schedule; and outputting an option capable of changing the operation of the device related to the first schedule based on the overlapping section between the first schedule and the second schedule.

According to various embodiments, the outputting may include: identifying another device used in association with the device of the first schedule based on the calendar application, acquiring schedule information associated with operation of the other device, generating at least one third schedule based on the schedule information, and outputting an option including the third schedule.

According to various embodiments, the outputting may include: identifying schedule information related to at least one other users based on the calendar application when the time information of the first schedule and the time information of the second schedule at least partially overlap each other, selecting a user for control of the device based on the identified schedule information related to the at least one other users, and outputting an option for requesting operation related to the device from the selected user.

According to various embodiments, the outputting may include: searching for candidate users who can operate the device based on the schedule information related to the at least one other users, and selecting the user for the control of the device according to a frequency ranking of using the device from the candidate users.

According to various embodiments, the outputting may include: identifying time information that does not overlaps between the time information of the first schedule and the time information of the second schedule, identifying an operation mode of the device based on the identified time information, and outputting an option for changing an operation required time of the device based on the operation mode.

According to various embodiments, the method of operating the electronic device 101 may further include: acquiring a user input related to the option; changing the time information of the first schedule when the user input is a response of changing the operation of the device, and registering the first schedule in the calendar application based on the changed time information; and acquiring a response of selected another user when the user input is a response of requesting the operation related to the device, and registering the time information of the first schedule in the calendar application based on the response of the other user.

According to various embodiments, the outputting may include: predicting the section in which the time information between the schedules at least partially overlaps each other in the calendar application using a leaning model trained using an AI algorithm, and acquiring recommendation information related to the operation of the device based on the at least partially overlapping section.

According to various embodiments, the outputting includes: predicting the section in which the time information between the schedules at least partially overlaps each other in the calendar application using a leaning model trained using at least one of machine learning, neural network, genetic, deep leaning, or classification algorithm as the AI algorithm, and acquiring recommendation information related to the operation of the device based on the at least partially overlapping section.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a display; and
at least one processor configured to be connected to the display,
wherein the processor is configured to:
acquire schedule information associated with an operation of a device from a user,
generate at least one first schedule based on the schedule information,
identify at least one second schedule stored in a calendar application,
identify a section in which time information of the first schedule and time information of the second schedule at least partially overlap each other by comparing the time information of the first schedule with the time information of the second schedule, and
output an option capable of changing the operation of the device related to the first schedule based on the at least partially overlapping section between the first schedule and the second schedule.

2. The electronic device of claim 1, wherein the processor is further configured to:
identify another device used in association with the device of the first schedule based on the calendar application;
acquire schedule information associated with operation of the other device;
generate at least one third schedule based on the schedule information; and
output an option including the third schedule.

3. The electronic device of claim 2, wherein the processor is further configured to:
identify schedule information related to at least one other users based on the calendar application based on the time information of the first schedule and the time information of the second schedule at least partially overlap each other;
select a user for control of the device based on the identified schedule information related to the at least one other users; and
output an option for requesting operation related to the device from the selected user.

4. The electronic device of claim 3, wherein the processor is further configured to:
search for candidate users who can operate the device based on the schedule information related to the at least one other users; and
select the user for the control of the device according to a frequency ranking of using the device from the candidate users.

5. The electronic device of claim 1, wherein the calendar application includes a schedule related to at least one device and a schedule related to multiple users, and
wherein the calendar application is an application that can share the schedule related to multiple users among the multiple users.

6. The electronic device of claim 1, wherein the processor is further configured to:
transmit the schedule information related to the first schedule to an external server using a communication circuit; and
acquire schedule information related to the at least one second schedule stored in the calendar application from the external server.

7. The electronic device of claim 1, wherein the processor is further configured to:
identify time information that does not overlaps between the time information of the first schedule and the time information of the second schedule;
identify an operation mode of the device based on the identified time information; and
output an option for changing an operation required time of the device based on the operation mode.

8. The electronic device of claim 1, wherein the processor is further configured to:
acquire a user input related to the option;
change the time information of the first schedule when the user input is a response of changing the operation of the device; and
register the first schedule in the calendar application based on the changed time information.

9. The electronic device of claim 8, wherein the processor is further configured to:
acquire a response of a selected another user based on the user input being a response of requesting the operation related to the device, and
register the time information of the first schedule in the calendar application based on the response of the other user.

10. The electronic device of claim 8, wherein the user input includes at least one of a voice input or a manual input.

11. The electronic device of claim 1, wherein the processor is further configured to:
predict the section in which the time information between the schedules at least partially overlaps each other in the calendar application using a leaning model trained using an artificial intelligent (AI) algorithm; and
acquire recommendation information related to the operation of the device based on the at least partially overlapping section.

12. The electronic device of claim 1, wherein the processor is further configured to:
predict the section in which the time information between the schedules at least partially overlaps each other in the calendar application using a leaning model trained using at least one of machine learning, neural network, genetic, deep leaning, or classification algorithm as an AI algorithm; and
acquire recommendation information related to the operation of the device based on the at least partially overlapping section.

13. An electronic device comprising:
a communication circuit;
an output device; and
at least one processor configured to be connected to the communication circuit and the output device,
wherein the processor is configured to:
acquire schedule information associated with an operation of the electronic device from a user,
generate a schedule based on the schedule information,
transmit the schedule information to an external server using the communication circuit,
acquire options capable of changing the operation of the electronic device related to the schedule,
output the options using the output device,
select any one option of the options based on a user input, and
change the schedule based on schedule information of the selected option.

14. A method of operating an electronic device, comprising:
acquiring schedule information associated with an operation of a device from a user;
generating at least one first schedule based on the schedule information;
identifying at least one second schedule stored in a calendar application;
identifying a section in which time information of the first schedule and time information of the second schedule at least partially overlap each other by comparing the time information of the first schedule with the time information of the second schedule; and
outputting an option capable of changing the operation of the device related to the first schedule based on the at least partially overlapping section between the first schedule and the second schedule.

15. The method of claim 14, wherein the outputting comprises:
identifying another device used in association with the device of the first schedule based on the calendar application;
acquiring schedule information associated with operation of the other device;
generating at least one third schedule based on the schedule information; and
outputting an option including the third schedule.

16. The method of claim 15, wherein the outputting further comprises:
identifying schedule information related to at least one other users based on the calendar application based on the time information of the first schedule and the time information of the second schedule at least partially overlapping each other;
selecting a user for control of the device based on the identified schedule information related to the at least one other users; and
outputting an option for requesting operation related to the device from the selected user.

17. The method of claim 16, wherein the outputting further comprises:
searching for candidate users who can operate the device based on the schedule information related to the at least one other users; and
selecting the user for the control of the device according to a frequency ranking of using the device from the candidate users.

18. The method of claim 14, wherein the outputting comprises:
identifying time information that does not overlaps between the time information of the first schedule and the time information of the second schedule;
identifying an operation mode of the device based on the identified time information; and
outputting an option for changing an operation required time of the device based on the operation mode.

19. The method of claim 14, further comprising:
acquiring a user input related to the option;
changing the time information of the first schedule based on the user input being a response of changing the operation of the device, and registering the first schedule in the calendar application based on the changed time information;
acquiring a response of selected another user when the user input is a response of requesting the operation related to the device; and
registering the time information of the first schedule in the calendar application based on the response of the other user.

20. The method of claim 14, wherein the outputting comprises:
predicting the section in which the time information between the schedules at least partially overlaps each other in the calendar application using a leaning model trained using an AI algorithm; and
acquiring recommendation information related to the operation of the device based on the at least partially overlapping section.
